(19) United States
(12) Patent Application Publication
(10) Pub. No.: US 2018/0119003 A1
(43) Pub. Date: May 3, 2018

(54) Carbon Dioxide-Viscosifiable Compositions for Subterranean Treatment

(71) Applicant: Halliburton Energy Services, Inc., Houston, TX (US)

(72) Inventors: Sairam Eluru, Pune (IN); Pratiksha Shivaji Meher, Pune (IN); Ravikant S. Belakshe, Pune (IN)

(73) Assignee: Halliburton Energy Services, Inc., Houston, TX (US)

(21) Appl. No.: 15/565,364

(22) PCT Filed: May 8, 2015
(86) PCT No.: PCT/US2015/029908

§ 371 Date: Oct. 9, 2017

(51) Int. Cl. C09K 8/68; C09K 8/575

(52) U.S. Cl. CPC C09K 8/68; C09K 2208/10; C09K 8/575

(57) ABSTRACT

Various embodiments disclosed relate to carbon dioxide-viscosifiable compositions for subterranean treatment. In various embodiments, the present invention provides a method of treating a subterranean formation. The method includes placing in a subterranean formation an aqueous composition including a compound including at least one secondary or tertiary amine group. The method also includes bubbling a gas including CO2 through the aqueous composition sufficient to protonate or carboxylate the amine group and increase the viscosity of the aqueous composition.

### BACKGROUND

Crosslinked polysaccharide viscosifiers, such as those formed from guar, guar derivatives, xanthan, and diutan, are frequently used for subterranean fracturing operations. Some viscoelastic surfactants can leave behind less residue and correspondingly cause less formation damage, making them attractive alternatives. However, a select type and amount of one or more counterion components is typically required for viscoelastic surfactants to act as effective and stable viscosifiers.

### BRIEF DESCRIPTION OF THE FIGURES

The drawings illustrate generally, by way of example, but not by way of limitation, various embodiments discussed in the present document.

FIG. 1 illustrates a system or apparatus for delivering a composition to a subterranean formation, in accordance with various embodiments.

FIG. 2 illustrates the switching mechanism of the N,N,N′,N′-tetramethyl-1,3-propanediamine (TMPDA) sodium dodecyl sulfate (SDS) system, in accordance with various embodiments.

FIG. 3A illustrates a photograph of 250 mM SDS-TMPDA in the absence of CO₂, in accordance with various embodiments.

FIG. 3B illustrates a photograph of 250 mM SDS-TMPDA(B) after bubbling CO₂ (0.1 MPa) at ambient temperature, in accordance with various embodiments.

FIG. 4A illustrates steady rheology of a SDS-TMPDA solution, in accordance with various embodiments.

FIG. 4B illustrates concentration dependence of zero-shear viscosity of a SDS-TMPDA solution, in accordance with various embodiments.

FIG. 5A illustrates the steady state rheology of a 2.0 wt % octadecyl dipropylene triamine (ODPTA) dispersion at 30° C. showing the effect of bubbling CO₂, in accordance with various embodiments.

FIG. 5B illustrates dynamic rheology of a 2.0 wt % ODPTA dispersion at 30° C. showing the effect of bubbling CO₂, in accordance with various embodiments.

FIG. 6 illustrates N-erucamidopropyl-N,N-dimethylamine (EPDM) with and without exposure to CO₂, in accordance with various embodiments.

FIG. 7A illustrates a flow curve of EPDM before and after exposure to CO₂ at ambient temperature, in accordance with various embodiments.

FIG. 7B illustrates the dynamic rheology of EPDM aqueous solution in the presence of CO₂, in accordance with various embodiments.

FIG. 8 illustrates the molecular structure of the triblock copolymer O₁₁₃F₁₁₀E₂₁₂ and a schematic representation of the micellar morphology after sequentially bubbling and removing CO₂, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. A comma can be used as a delimiter or digit group separator to the left or right of a decimal mark; for example, “0.000,1” is equivalent to “0.0001.” All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, within 1%, or within 0% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “organic group” as used herein refers to but is not limited to any carbon-containing functional group. For example, an oxygen-containing group such as an alkoxy group, aryloxy group, aralkyloxy group, oxo(carbonyl) group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can itself be substituted or unsubstituted.

The term “substituted” as used herein refers to an organic group as defined herein or molecule in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “acyl” as used herein refers to a group containing a carbonyl moiety wherein the group is bonded via the carbonyl carbon atom. The carbonyl carbon atom is also bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. In the special case wherein the carbonyl carbon atom is bonded to a hydrogen, the group is a “formyl” group, an acyl group as the term is defined herein. An acyl group can include 0 to about 12-20 or 12-40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” as used herein refers to cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed herein.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include one to about 12-20 or about 12-40 carbon atoms bonded to the oxygen atom, and can further include double or triple bonds, and can also include heteroatoms. For example, an allyloxy group is an alkoxy group within the meaning herein. A methoxyethoxy group is also an alkoxy group within the meaning herein, as is a methylenedioxy group in a context where two adjacent atoms of a structure are substituted therewith.

The term “amine” as used herein refers to primary, secondary, and tertiary amines having, e.g., the formula N(group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The term “amino group” as used herein refers to a substituent of the form —NH₂, —NHR, —NR₂, —NR₃⁺, wherein each R is independently selected, and protonated forms of each, except for —NR₃⁺, which cannot be protonated. Accordingly, any compound substituted with an amino group can be viewed as an amine. An “amino group” within the meaning herein can be a primary, secondary, tertiary, or quaternary amino group. An “alkylamino” group includes a monoalkylamino, dialkylamino, and trialkylamino group.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” as used herein refers to a functional group or molecule that includes carbon and hydrogen atoms. The term can also refer to a functional group or molecule that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof.

The term “solvent” as used herein refers to a liquid that can dissolve a solid, liquid, or gas. Non-limiting examples of solvents are silicones, organic compounds, water, alcohols, ionic liquids, and supercritical fluids.

The term “number-average molecular weight” as used herein refers to the ordinary arithmetic mean of the molecular weight of individual molecules in a sample. It is defined as the total weight of all molecules in a sample divided by the total number of molecules in the sample. Experimentally, the number-average molecular weight (Mₙ) is determined by analyzing a sample divided into molecular weight fractions of species i having nᵢ molecules of molecular weight Mᵢ through the formula Mₙ=ΣMᵢnᵢ/Σnᵢ. The number-average molecular weight can be measured by a variety of well-known methods including gel permeation chromatography, spectroscopic end group analysis, and osmometry. If unspecified, molecular weights of polymers given herein are number-average molecular weights.

The term “room temperature” as used herein refers to a temperature of about 15° C. to 28° C.

The term “standard temperature and pressure” as used herein refers to 20° C. and 101 kPa.

As used herein, “degree of polymerization” is the number of repeating units in a polymer.

As used herein, the term “polymer” refers to a molecule having at least one repeating unit and can include copolymers.

The term “copolymer” as used herein refers to a polymer that includes at least two different repeating units. A copolymer can include any suitable number of repeating units.

The term “downhole” as used herein refers to under the surface of the earth, such as a location within or fluidly connected to a wellbore.

As used herein, the term “drilling fluid” refers to fluids, slurries, or muds used in drilling operations downhole, such as during the formation of the wellbore.

As used herein, the term “stimulation fluid” refers to fluids or slurries used downhole during stimulation activities of the well that can increase the production of a well, including perforation activities. In some examples, a stimulation fluid can include a fracturing fluid or an acidizing fluid.

As used herein, the term “clean-up fluid” refers to fluids or slurries used downhole during clean-up activities of the well, such as any treatment to remove material obstructing the flow of desired material from the subterranean formation. In one example, a clean-up fluid can be an acidification treatment to remove material formed by one or more perforation treatments. In another example, a clean-up fluid can be used to remove a filter cake.

As used herein, the term “fracturing fluid” refers to fluids or slurries used downhole during fracturing operations.

As used herein, the term “spotting fluid” refers to fluids or slurries used downhole during spotting operations, and can be any fluid designed for localized treatment of a downhole region. In one example, a spotting fluid can include a lost circulation material for treatment of a specific section of the wellbore, such as to seal off fractures in the wellbore and prevent sag. In another example, a spotting fluid can include a water control material. In some examples, a spotting fluid can be designed to free a stuck piece of drilling or extraction equipment, can reduce torque and drag with drilling lubricants, prevent differential sticking, promote wellbore stability, and can help to control mud weight.

As used herein, the term “completion fluid” refers to fluids or slurries used downhole during the completion phase of a well, including cementing compositions.

As used herein, the term “remedial treatment fluid” refers to fluids or slurries used downhole for remedial treatment of a well. Remedial treatments can include treatments designed to increase or maintain the production rate of a well, such as stimulation or clean-up treatments.

As used herein, the term “abandonment fluid” refers to fluids or slurries used downhole during or preceding the abandonment phase of a well.

As used herein, the term “acidizing fluid” refers to fluids or slurries used downhole during acidizing treatments. In one example, an acidizing fluid is used in a clean-up operation to remove material obstructing the flow of desired material, such as material formed during a perforation operation. In some examples, an acidizing fluid can be used for damage removal.

As used herein, the term “cementing fluid” refers to fluids or slurries used during cementing operations of a well. For example, a cementing fluid can include an aqueous mixture including at least one of cement and cement kiln dust. In another example, a cementing fluid can include a curable resinous material such as a polymer that is in an at least partially uncured state.

As used herein, the term “water control material” refers to a solid or liquid material that interacts with aqueous material downhole, such that hydrophobic material can more easily travel to the surface and such that hydrophilic material (including water) can less easily travel to the surface. A water control material can be used to treat a well to cause the proportion of water produced to decrease and to cause the proportion of hydrocarbons produced to increase, such as by selectively binding together material between water-producing subterranean formations and the wellbore while still allowing hydrocarbon-producing formations to maintain output.

As used herein, the term “packer fluid” refers to fluids or slurries that can be placed in the annular region of a well between tubing and outer casing above a packer. In various examples, the packer fluid can provide hydrostatic pressure in order to lower differential pressure across the sealing element, lower differential pressure on the wellbore and casing to prevent collapse, and protect metals and elastomers from corrosion.

As used herein, the term “fluid” refers to liquids and gels, unless otherwise indicated.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, conformance, completion, cementing, remedial treatment, abandonment, and the like.

As used herein, a “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, and a fluid connection across a screen, across gravel pack, across proppant, including across resin-bonded proppant or proppant deposited in a fracture, and across sand. A flow pathway can include a natural subterranean passageway through which fluids can flow. In some embodiments, a flow pathway can be a water source and can include water. In some embodiments, a flow pathway can be a petroleum source and can include petroleum. In some embodiments, a flow pathway can be sufficient to divert from a wellbore, fracture, or flow pathway connected thereto at least one of water, a downhole fluid, or a produced hydrocarbon.

As used herein, a “carrier fluid” refers to any suitable fluid for suspending, dissolving, mixing, or emulsifying with one or more materials to form a composition. For example, the carrier fluid can be at least one of crude oil, dipropylene glycol methyl ether, dipropylene glycol dimethyl ether, dipropylene glycol methyl ether, dipropylene glycol dimethyl ether, dimethyl formamide, diethylene glycol methyl ether, ethylene glycol butyl ether, diethylene glycol butyl ether, butylglycidyl ether, propylene carbonate, D-limonene, a C₂-C₄₀ fatty acid C₁-C₁₀ alkyl ester (e.g., a fatty acid methyl ester), tetrahydrofurfuryl methacrylate, tetrahydrofurfuryl acrylate, 2-butoxy ethanol, butyl acetate, butyl lactate, furfuryl acetate, dimethyl sulfoxide, dimethyl formamide, a petroleum distillation product or fraction (e.g., diesel, kerosene, napthas, and the like) mineral oil, a hydrocarbon oil, a hydrocarbon including an aromatic carbon-carbon bond (e.g., benzene, toluene), a hydrocarbon including an alpha olefin, xylenes, an ionic liquid, methyl ethyl ketone, an ester of oxalic, maleic or succinic acid, methanol, ethanol, propanol (iso- or normal-), butyl alcohol (iso-, tert-, or normal-), an aliphatic hydrocarbon (e.g., cyclohexanone, hexane), water, brine, produced water, flowback water, brackish water, and sea water. The fluid can form about 0.001 wt % to about 99.999 wt % of a composition, or a mixture including the same, or about 0.001 wt % or less, 0.01 wt %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt % or more.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

A compound herein having a positively charged counterion can include any suitable positively charged counterion. For example, the counterion can hydrogen (H⁺), ammonium(NH₄⁺), or an alkali metal such as sodium (Na⁺), potassium (K⁺), or lithium (Li⁺). In some embodiments, the counterion can have a positive charge greater than +1, which can in some embodiments complex to multiple ionized groups, such as Zn²⁺, Al³⁺, or alkaline earth metals such as Ca²⁺ or Mg²⁺.

A compound herein having a negatively charged counterion can include any suitable negatively charged counterion. For example, the counterion can be a halide, such as fluoride, chloride, iodide, or bromide. In other examples, the counterion can be nitrate, hydrogen sulfate, dihydrogen phosphate, bicarbonate, nitrite, perchlorate, iodate, chlorate, bromate, chlorite, hypochlorite, hypobromite, cyanide, amide, cyanate, hydroxide, permanganate. The counterion can be a conjugate base of any carboxylic acid, such as acetate or formate. In some embodiments, a counterion can have a negative charge greater than −1, which can in some embodiments complex to multiple ionized groups, such as oxide, sulfide, nitride, arsenate, phosphate, arsenite, hydrogen phosphate, sulfate, thiosulfate, sulfite, carbonate, chromate, dichromate, peroxide, or oxalate.

In various embodiments, the present invention provides a method of treating a subterranean formation. The method includes placing in a subterranean formation an aqueous composition that includes a compound including at least one secondary or tertiary amine group. The method also includes bubbling a gas including CO₂ through the aqueous composition sufficient to protonate or carboxylate the amine group and increase the viscosity of the aqueous composition.

In various embodiments, the present invention provides a method of treating a subterranean formation. The method includes placing in a subterranean formation an aqueous composition including a compound including at least one secondary or tertiary amine group, wherein at least one of Conditions (A), (B), and (C) are satisfied. In Condition (A), the compound including the amine has the structure:

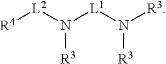

In Condition (A), at least one of Conditions (A1), (A2), and (A3) are satisfied. In Condition (A1), L¹ is —(C₁-C₁₀)alkylene-, L² is a bond, R³ is (C₁-C₁₀)hydrocarbyl, and R⁴ is R³. In Condition (A2), L¹ is —(C₁-C₁₀)alkylene-, L² is (C₁-C₁₀)hydrocarbylene-(NR²—(C₁-C₁₀)hydrocarbylene)ₙ-, at each occurrence, n is independently about 1 to about 10, at each occurrence R³ is chosen from —H and (C₁-C₁₀)hydrocarbyl, and R⁴ is (C₅-C₉₀)alkyl interrupted by 0, 1, 2, or 3 ethenylene groups. In Condition (A3), L¹ is —C(O)—(C₁-C₉)alkyl-, L² is a bond, R³ is (C₁-C₁₀)hydrocarbyl, and R⁴ is (C₅-C₉₀)alkyl interrupted by 0, 1, 2, or 3 alkenylene groups. In Condition (B) the compound including the amine has the structure:

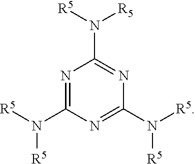

At each occurrence R⁵ is independently chosen from —H, (C₁-C₂₀)alkyl, and (C₁-C₂₀)alkyl-NR⁶₂. Each R⁵-substituted amino group has at least one R⁵ that is H. At each occurrence R⁶ is independently (C₁-C₂₀)alkyl. In Condition (C), the compound including the at least one secondary or tertiary amine is a polymer including at least one repeating group that includes at least one of the one or more secondary or tertiary amines, the repeating group having the structure:

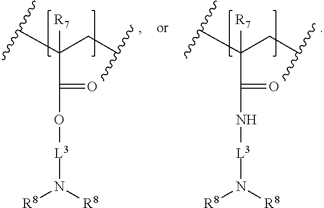

The variable R⁷ is chosen from —H and a substituted or unsubstituted (C₁-C₅)alkyl group. The variable L³ is (C₁-C₁₀₀)alkylene. The variable R⁸ is independently (C₁-C₁₀)alkyl. The method includes bubbling a gas including CO₂ through the aqueous composition sufficient to protonate or carboxylate the amine group and increase the viscosity of the aqueous composition. The method also includes at least one of fracturing the subterranean formation with the composition or gravel packing the subterranean formation with the composition. In some embodiments, the aqueous composition includes a nanomaterial.

In various embodiments, the present invention provides a system including an aqueous composition including a compound including at least one secondary or tertiary amine group. The system also includes a subterranean formation including the composition therein.

In various embodiments, the present invention provides an aqueous composition for fracturing or gravel packing of a subterranean formation. The composition includes a compound including at least one secondary or tertiary amine group.

In various embodiments, the present invention provides an aqueous composition for treatment of a subterranean formation. The composition includes a compound including at least one secondary or tertiary amine group, wherein at least one of Conditions (A), (B), and (C) is satisfied. In Condition (A), the compound including the amine has the structure:

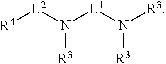

In Condition (A), at least one of Conditions (A1), (A2), and (A3) is satisfied. In Condition (A1), L¹ is —(C₁-C₁₀)alkylene-, L² is a bond, R³ is (C₁-C₁₀)hydrocarbyl, and R⁴ is R³. In Condition (A2), L¹ is —(C₁-C₁₀)alkylene-, L² is (C₁-C₁₀)hydrocarbylene-(NR²—(C₁-C₁₀)hydrocarbylene)ₙ₋, at each occurrence, n is independently about 1 to about 10, at each occurrence R³ is chosen from —H and (C₁-C₁₀)hydrocarbyl, and R⁴ is (C₅-C₉₀)alkyl interrupted by 0, 1, 2, or 3 ethenylene groups. In Condition (A3), L¹ is —C(O)—(C₁-C₉)alkyl-, L² is a bond, R³ is (C₁-C₁₀)hydrocarbyl, and R⁴ is (C₅-C₉₀)alkyl interrupted by 0, 1, 2, or 3 alkenylene groups. In Condition (B) the compound including the amine has the structure:

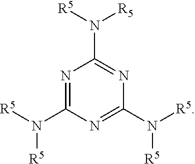

At each occurrence R⁵ is independently chosen from —H, (C₁-C₂₀)alkyl, and (C₁-C₂₀)alkyl-NR⁶₂. Each R⁵-substituted amino group has at least one R⁵ that is H. At each occurrence R⁶ is independently (C₁-C₂₀)alkyl. In Condition (C), the compound including the at least one secondary or tertiary amine is a polymer including at least one repeating group that includes at least one of the one or more secondary or tertiary amines, the repeating group having the structure:

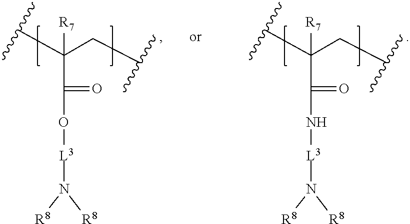

The variable R⁷ is chosen from —H and a substituted or unsubstituted (C₁-C₅)alkyl group. The variable L³ is (C₁-C₁₀)alkylene. The variable R⁸ is independently (C₁-C₁₀)alkyl. In some embodiments, the aqueous composition includes a nanomaterial.

In various embodiments, the present invention provides a method of preparing a composition for treatment of a subterranean formation. The method includes forming an aqueous composition including a compound including at least one secondary or tertiary amine group.

In various embodiments, the present invention provides certain advantages over other viscosifier compositions and methods for their use. In various embodiments, the carbon dioxide-viscosifiable composition can be easier to prepare and use, with no need for selection, measurement, or addition of one or more counterion components. In various embodiments, the carbon dioxide-viscosifiable composition can be easier to decrease in viscosity and remove from a subterranean formation than other viscosifiers, such as by applying nitrogen gas. In various embodiments, the carbon dioxide-viscosifiable composition can leave behind less residue in the subterranean formation than other viscosifiers. In various embodiments, the carbon dioxide-viscosifiable composition provides effective high viscosity under a wider range of conditions than other viscosified compositions, such as under at least one of higher temperature conditions and using water having a higher total dissolved solids.

In various embodiments, viscosification of the carbon dioxide-viscosifiable composition can be delayed until the composition reaches a particular desired subterranean location, making the composition easier to pump to the subterranean location and providing a greater ability to target specific subterranean locations. In various embodiments, the carbon dioxide-viscosifiable composition is less expensive and easier to use than other viscosified compositions for subterranean use. In various embodiments, the carbon dioxide-viscosifiable composition can provide more effective and less expensive subterranean treatments, such as fracturing or gravel packing operations.

### Method of Treating a Subterranean Formation.

In some embodiments, the present invention provides a method of treating a subterranean formation. The method can include placing in a subterranean formation a composition including a compound including at least one secondary or tertiary amine group, such as any suitable compound including at least one secondary or tertiary amine group described herein. The method can also include, at least one of before, after, and during the placing, bubbling a gas including CO₂ through the aqueous composition. The bubbling of the gas including CO₂ through the aqueous composition is sufficient to protonate or carboxylate the amine group and increase the viscosity of the aqueous composition. The compound having a protonated or carboxylated amine group can act as a viscosifier. The aqueous composition can be a viscoelastic fluid system. In various embodiments, the method includes using the aqueous composition for fracturing the subterranean formation, or for gravel packing the formation (e.g., gravel packing of unconsolidated sand).

The placing of the composition in the subterranean formation can include contacting the composition and any suitable part of the subterranean formation, or contacting the composition and a subterranean material, such as any suitable subterranean material. The subterranean formation can be any suitable subterranean formation. In some examples, the placing of the composition in the subterranean formation includes contacting the composition with or placing the composition in at least one of a fracture, at least a part of an area surrounding a fracture, a flow pathway, an area surrounding a flow pathway, and an area desired to be fractured. The placing of the composition in the subterranean formation can include at least partially depositing the composition in a fracture, flow pathway, or area surrounding the same. In some embodiments, the method includes obtaining or providing the composition including the compound including the at least one amine. The obtaining or providing of the composition can occur at any suitable time and at any suitable location. The obtaining or providing of the composition can occur above the surface. The obtaining or providing of the composition can occur in the subterranean formation (e.g., downhole).

The method can include, at least one of before, after, and during the placing, bubbling a gas including CO₂ through the aqueous composition. The bubbling can occur before the placing. The bubbling can occur during the placing. The bubbling can occur after the placing. The bubbling of the gas including CO₂ can be performed using any suitable technique, for any suitable duration, and using any suitable quantity of CO₂. In some embodiments, the gas including CO₂ is air. In some embodiments, the gas including CO₂ has a higher concentration of CO₂ than air. The bubbling of the gas including CO₂ through the aqueous composition is sufficient to protonate or carboxylate the amine group and increase the viscosity of the aqueous composition. In a compound that has multiple amine groups, the bubbling of the gas including CO₂ is sufficient to protonate or carboxylate at least one or more of the amine groups, such that viscosity of the aqueous composition is increased.

The increase in viscosity can be any increase in viscosity. The increase in viscosity can transform the composition into a viscoelastic gel. The protonation or carboxylation of the amine group on the compound can allow the composition to form an aqueous emulsion, which can cause an increase in the viscosity of the aqueous composition. The protonation or carboxylation of the amine group on the compound can allow the compound to form micellar structures, such as worm-like micelles (e.g., non-spherical elongated micelles). The micellar structures can cause an increase in the viscosity of the aqueous composition.

The method can include bubbling a gas through the composition sufficient to deprotonate or decarboxylate the amine group and correspondingly decrease the viscosity of the aqueous composition. The gas can include or be, for example, nitrogen or a nitrogen-containing gas such as air, or a noble gas. The bubbling to deprotonate or decarboxylate the amine group can be performed after the composition is used for its intended use downhole, such as for fracturing or gravel packing.

The method can include hydraulic fracturing, such as a method of hydraulic fracturing to generate a fracture or flow pathway. The placing of the composition in the subterranean formation or the contacting of the subterranean formation and the hydraulic fracturing can occur at any time with respect to one another; for example, the hydraulic fracturing can occur at least one of before, during, and after the contacting or placing. In some embodiments, the contacting or placing occurs during the hydraulic fracturing, such as during any suitable stage of the hydraulic fracturing, such as during at least one of a pre-pad stage (e.g., during injection of water with no proppant, and additionally optionally mid- to low-strength acid), a pad stage (e.g., during injection of fluid only with no proppant, with some viscosifier, such as to begin to break into an area and initiate fractures to produce sufficient penetration and width to allow proppant-laden later stages to enter), or a slurry stage of the fracturing (e.g., viscous fluid with proppant). The method can include performing a stimulation treatment at least one of before, during, and after placing the composition in the subterranean formation in the fracture, flow pathway, or area surrounding the same. The stimulation treatment can be, for example, at least one of perforating, acidizing, injecting of cleaning fluids, propellant stimulation, and hydraulic fracturing. In some embodiments, the stimulation treatment at least partially generates a fracture or flow pathway where the composition is placed in or contacted to, or the composition is placed in or contacted to an area surrounding the generated fracture or flow pathway.

In some embodiments, the method can include bubbling CO₂ gas through the aqueous composition including the compound including the at least one secondary or tertiary amine group. The method can optionally include adding a nanomaterial to the composition before or after the bubbling. The method can include pumping the mixture downhole as a pad fluid above fracture pressure to hydraulically fracture the subterranean formation. The method can optionally include deprotonating or decarboxylating the amine group, such as by pumping nitrogen or air downhole, to reduce the viscosity of the composition and allow flow back.

In some embodiments, the method can include bubbling CO₂ gas through the aqueous composition including the compound including the at least one secondary or tertiary amine group. The method can optionally include adding a nanomaterial to the composition before or after the bubbling. The method can include adding one or more suitable proppants to the composition, and pumping the composition downhole to place the proppant and to optionally enhance the fracture geometry. The method can optionally include deprotonating or decarboxylating the amine group, such as by pumping nitrogen or air downhole, to reduce the viscosity of the composition and allow flow back.

In some embodiments, the method can include bubbling CO₂ gas through the aqueous composition including the compound including the at least one secondary or tertiary amine group. The method can optionally include adding a nanomaterial to the composition before or after the bubbling. The method can optionally include incorporating a desired gravel into the composition and pumping the composition downhole below fracture pressure to place the gravel in front of a sand-producing zone. After effective packing of gravel and sand, the method can optionally include deprotonating or decarboxylating the amine group, such as by pumping nitrogen or air downhole, to reduce the viscosity of the composition and allow flow back.

The water in the aqueous composition can be any suitable water, such as fresh water, brine, produced water, flowback water, brackish water, and sea water. The water can include a salt (e.g., brine) that can be any suitable one or more salts, such as at least one of NaBr, CaCl₂, CaBr₂, ZnBr₂, KCl, NaCl, a carbonate salt, a sulfonate salt, a phosphonate salt, a magnesium salt, a bromide salt, a formate salt, an acetate salt, and a nitrate salt. The water can have any suitable total dissolved solids level, such as about 1,000 mg/L to about 250,000 mg/L, or about 1,000 mg/L or less, or about 5,000 mg/L, 10,000, 15,000, 20,000, 25,000, 30,000, 40,000, 50,000, 75,000, 100,000, 125,000, 150,000, 175,000, 200,000, 225,000, or about 250,000 mg/L or more. The water can have any suitable salt concentration, such as about 1,000 ppm to about 300,000 ppm, or about 1,000 ppm to about 150,000 ppm, or about 1,000 ppm or less, or about 5,000 ppm, 10,000, 15,000, 20,000, 25,000, 30,000, 40,000, 50,000, 75,000, 100,000, 125,000, 150,000, 175,000, 200,000, 225,000, 250,000, 275,000, or about 300,000 ppm or more. In some examples, the water can have a concentration of at least one of NaBr, CaCl₂, CaBr₂, ZnBr₂, KCl, and NaCl of about 0.1% w/v to about 20% w/v, or about 0.1% w/v or less, or about 0.5% w/v, 1, 2, 3, 4, 5, 6, 7, 8, 9, 10, 11, 12, 13, 14, 15, 16, 17, 18, 19, 20, 21, 22, 23, 24, 25, 26, 27, 28, 29, or about 30% w/v or more. The aqueous composition can have any suitable water content, such as about 0.01 wt % to about 99 wt %, or about 0.01 wt % or less, or about 0.1 wt %, 1, 2, 3, 4, 5, 6, 8, 10, 15, 20, 30, 40, 50, 60, 70, 80, 90, 95, 96, 97, 98, or about 99 wt % or more. In some embodiments, the aqueous composition can include one or more water-miscible liquids, such as methanol, ethanol, ethylene glycol, propylene glycol, glycerol, and the like. In various embodiments, the aqueous composition can include one or more organic solvents or oils.

Any suitable proportion of the aqueous composition can be the compound including the amine. For example, about 0.01 wt % to about 99 wt % of the composition can be the compound including the amine, about 0.01 wt % to about 50 wt %, or about 0.01 wt % or less, or about 0.1 wt %, 1, 2, 3, 4, 5, 6, 8, 10, 15, 20, 25, 30, 35, 40, 45, 50, 55, 60, 65, 70, 75, 80, 85, 90, 95, 96, 97, 98, or 99 wt % or more.

### Compound Including at Least One Secondary or Tertiary Amine Group.

The composition includes at least one secondary or tertiary amine group. A secondary amine group is an amine group having at least two non-hydrogen substituents. A tertiary amine group is an amine group having at least three non-hydrogen substituents. The compound can have one secondary or tertiary amine group, or more than one secondary or tertiary amine group. The secondary or tertiary amine group can be protonated or carboxylated. In various embodiments, the thermal stability of the compound can be adjusted by increasing or decreasing the basicity or the number of the amine groups.

A protonated amine group can be an ammonium group having the structure:

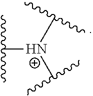 [SMILES: *[NH+](*)*]

A carboxylated amine group can have any suitable structure, such that the compound increases the viscosity of the aqueous composition. In some embodiments, the carboxylated amine group has the structure:

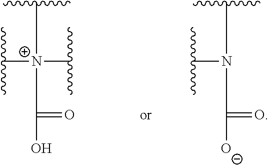 [SMILES: *[N+](*)(*)C(=O)O ; *N(*)C(=O)[O-]]

In some embodiments, the compound including the amine can have the structure:

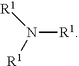

At each occurrence, R¹ can be independently chosen from —H and substituted or unsubstituted (C₁-C₁₀₀)hydrocarbyl optionally interrupted by 0, 1, 2, or 3 groups independently chosen from —O—, —S—, substituted or unsubstituted —NH—, —(O—(C₁-C₁₀)hydrocarbylene)ₙ-, and —(NR²—(C₁-C₁₀)hydrocarbylene)ₙ-. At each occurrence, R¹ can be independently chosen from —H and (C₁-C₁₀₀)hydrocarbyl optionally interrupted by 0, 1, 2, or 3 groups independently chosen from —O—, —S—, substituted or unsubstituted —NH—, —(O—(C₁-C₅)alkyl)ₙ-, and —(NR²—(C₁-C₅)alkyl)ₙ-, wherein each (C₁-C₅)alkyl is independently substituted or unsubstituted. At each occurrence, R² can be independently chosen from —H and —(NR¹—(C₁-C₁₀)hydrocarbylene)ₙ-. At each occurrence, R² is independently chosen from —H and —(NR¹—(C₁-C₅)hydrocarbylene)ₙ-. Each (C₁-C₁₀)hydrocarbyl can be independently substituted or unsubstituted. At each occurrence, n can be independently about 1 to about 10,000, about 1 to about 1,000, or about 1, 2, 3, 4, 5, 6, 8, 10, 15, 20, 25, 30, 40, 50, 60, 70, 80, 90, 100, 125, 150, 175, 200, 225, 250, 500, 750, 1,000, 1,500, 2,000, 2,500, 5,000, or about 10,000 or more.

In various embodiments, the compound including the amine can have the structure:

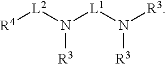

At each occurrence, R³ can be chosen from —H and substituted or unsubstituted (C₁-C₁₀)hydrocarbyl. The variable R³ can be (C₁-C₁₀)hydrocarbyl. The variable R³ can be methyl. At each occurrence, R⁴ can be chosen from —R³ and substituted or unsubstituted (C₅-C₁₀₀)hydrocarbyl. The variable R⁴ can be R³. The variable R⁴ can be methyl. At each occurrence, L¹ and L² can be each independently chosen from a bond, a (C₁-C₁₀)hydrocarbylene, and a (C₁-C₁₀)hydrocarbylene-(NR²—(C₁-C₁₀)hydrocarbylene)ₙ-, wherein each (C₁-C₁₀)hydrocarbylene is independently substituted or unsubstituted. The variable L¹ can be —(C₁-C₁₀)alkylene-. The variable L¹ can be -propylene-. The variable L² can be a bond. In some embodiments, L¹ can be —(C₁-C₁₀)alkylene-, L² can be a bond, R³ can be (C₁-C₁₀)hydrocarbyl, and R⁴ can be R³. In some embodiments, the compound including the amine group can have the structure:

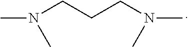

In various embodiments, the compound including the amine can have the structure:

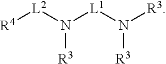

The variable R³ can be chosen from —H and substituted or unsubstituted (C₁-C₁₀)hydrocarbyl. The variable R³ can be chosen from —H and (C₁-C₁₀)hydrocarbyl. The variable R³ can be —H. At each occurrence, R⁴ can be chosen from —R³ and substituted or unsubstituted (C₅-C₁₀₀)hydrocarbyl. The variable R⁴ can be (C₅-C₁₀₀)hydrocarbyl. The variable R⁴ can be (C₅-C₉₀)alkyl interrupted by 0, 1, 2, or 3 ethenylene groups. The variable R⁴ can be a (C₁₈)alkyl. At each occurrence, L¹ and L² can be each independently chosen from a bond, a (C₁-C₁₀)hydrocarbylene, and a (C₁-C₁₀)hydrocarbylene-(NR²—(C₁-C₁₀)hydrocarbylene)ₙ₋, wherein each (C₁-C₁₀)hydrocarbylene is independently substituted or unsubstituted. The variable L¹ can be —(C₁-C₁₀)alkylene-. The variable L¹ can be -propylene-. The variable L² can be (C₁-C₁₀)hydrocarbylene-(NR²—(C₁-C₁₀)hydrocarbylene)ₙ₋. The variable L² can be (C₂-C₅)alkylene-(NR²(C₂-C₅)alkylene)ₙ-. At each occurrence, n can be independently about 1 to about 10,000, about 1 to about 1,000, or about 1, 2, 3, 4, 5, 6, 8, 10, 15, 20, 25, 30, 40, 50, 60, 70, 80, 90, 100, 125, 150, 175, 200, 225, 250, 500, 750, 1,000, 1,500, 2,000, 2,500, 5,000, or about 10,000 or more. In some embodiments, L¹ can be —(C₁-C₁₀)alkylene-, L² can be (C₁-C₁₀)hydrocarbylene-(NR²—(C₁-C₁₀)hydrocarbylene)ₙ₋, at each occurrence, n can be independently about 1 to about 10, at each occurrence R³ can be chosen from —H and (C₁-C₁₀)hydrocarbyl, and R⁴ is (C₅-C₉₀)alkyl interrupted by 0, 1, 2, or 3 ethenylene groups. The compound including the amine can have the structure:

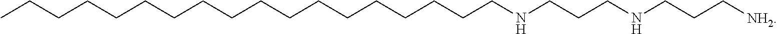 [SMILES: CCCCCCCCCCCCCCCCCCNCCCNCCCN]

In various embodiments, the compound including the amine can have the structure:

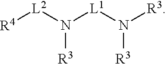

At each occurrence, R³ can be chosen from —H and substituted or unsubstituted (C₁-C₁₀)hydrocarbyl. The variable R³ can be (C₁-C₁₀)hydrocarbyl. The variable R³ can be methyl. At each occurrence, R⁴ can be chosen from —R³ and substituted or unsubstituted (C₅-C₁₀₀)hydrocarbyl. The variable R⁴ can be (C₅-C₁₀₀)hydrocarbyl. The variable R⁴ can be (C₅-C₉₀)alkyl interrupted by 0, 1, 2, or 3 alkenylene groups. The variable R⁴ can be —(CH₂)₁₁—CH═CH—(CH₂)₇CH₃. At each occurrence, L¹ and L² can be each independently chosen from a bond, a (C₁-C₁₀)hydrocarbylene, and a (C₁-C₁₀)hydrocarbylene-(NR²—(C₁-C₁₀)hydrocarbylene)ₙ-, wherein each (C₁-C₁₀)hydrocarbylene is independently substituted or unsubstituted. The variable L¹ can be —C(O)—(C₁-C₉)alkyl-. The variable L¹ can be —C(O)-propylene-. The variable L² can be a bond. In some embodiments, L can be —C(O)—(C₁-C₉)alkyl-, L² can be a bond, R³ can be (C₁-C₁₀)hydrocarbyl, and R⁴ can be (C₅-C₉₀)alkyl interrupted by 0, 1, 2, or 3 alkenylene groups. The compound including the amino group can have the structure:

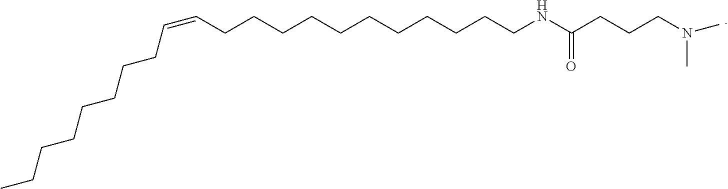 [SMILES: CCCCCCCC/C=C\CCCCCCCCCCCNC(=O)CCCN(C)C]

In various embodiments, the compound including the amine has the structure:

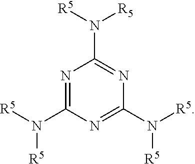

At each occurrence R⁵ can be independently chosen from —H and substituted or unsubstituted (C₁-C₂₀)hydrocarbyl-NR⁶₂ interrupted by 0, 1, 2, or 3 groups independently chosen from —O—, —S—, substituted or unsubstituted —NH—, —(O—(C₁-C₁₀)hydrocarbylene)ₙ-, and —(NR⁶—(C₁-C₁₀)hydrocarbylene)ₙ-. One R⁵-substituted amino group can have two R⁵ that are H. Two R⁵-substituted amino groups each can have two R⁵ that are H. At each occurrence R⁵ can be independently chosen from —H and (C₁-C₂₀)alkyl-NR⁶₂. At each occurrence, R⁶ can be independently chosen from —H, substituted or unsubstituted (C₁-C₂₀)hydrocarbyl, and —((C₁-C₁₀)hydrocarbylene-NR⁵)ₙ—, wherein each (C₁-C₁₀)hydrocarbyl can be independently substituted or unsubstituted. The variable R⁶ can be independently chosen from —H and (C₁-C₂₀)hydrocarbyl. The variable R⁶ can be independently chosen from —H and (C₁-C₂₀)alkyl. The variable R⁶ can be independently (C₁-C₂₀)alkyl. The variable R⁶ can be independently (C₁-C₅)alkyl. At each occurrence, n can be independently about 1 to about 10,000, about 1 to about 1,000, or about 1, 2, 3, 4, 5, 6, 8, 10, 15, 20, 25, 30, 40, 50, 60, 70, 80, 90, 100, 125, 150, 175, 200, 225, 250, 500, 750, 1,000, 1,500, 2,000, 2,500, 5,000, or about 10,000 or more. Each R⁵⁻substituted amino group can have at least one R⁵ that is H. In some embodiments, at each occurrence R⁵ can be independently chosen from —H, (C₁-C₂₀)alkyl, and (C₁-C₂₀)alkyl-NR⁶₂, each R⁵-substituted amino group can have at least one R⁵ that is H, and at each occurrence R⁶ can be independently (C₁-C₂₀)alkyl. In some embodiments, the compound including the amine group can have a structure chosen from:

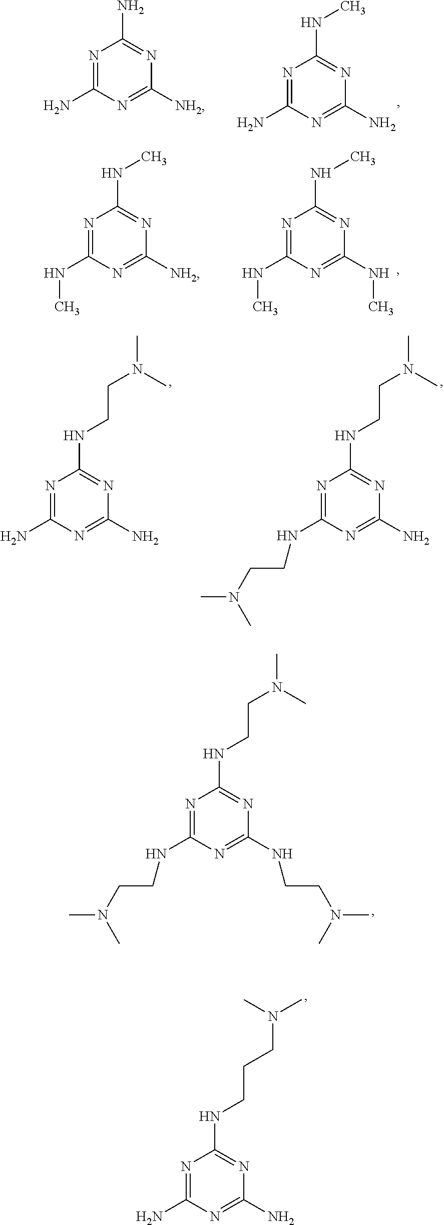

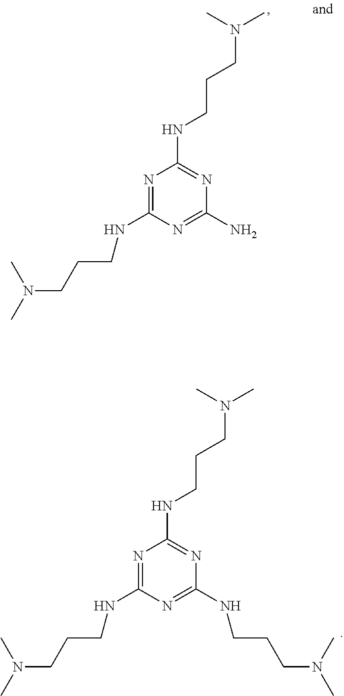

In various embodiments, the compound including the amine can be a polymer including at least one ethenylene repeating unit that includes the amine group as a substituent thereof, wherein the ethenylene repeating unit is otherwise substituted or unsubstituted. The amine can be bound to the ethenylene repeating unit via a —C(O)—O-L³- group, wherein L³ is a substituted or unsubstituted (C₁-C₂₀)hydrocarbylene. The polymer can further include a fluoro(C₁-C₁₀)alkyl methacrylate repeating group. The polymer can further include a fluorobutyl methacrylate repeating group. The polymer can further include a poly(oxy(C₂-C₅)alkylene) repeating unit. The polymer can further include a poly(oxyethylene) repeating unit. The polymer can further include a —O—C(O)—CH₂— unit, wherein the —CH₂— unit is substituted or unsubstituted. The polymer can further include a —O—C(O)—CR¹⁰₂— unit, wherein at each occurrence R¹⁰ is independently chosen from —H, a substituted or unsubstituted (C₁-C₅)alkyl, and a cyano group. The polymer can further include a —O—C(O)—C(CH₃)(CN)— unit.

The compound including the at least one secondary or tertiary amine can be a polymer including at least one repeating group that includes at least one of the one or more secondary or tertiary amines, the repeating group having the structure:

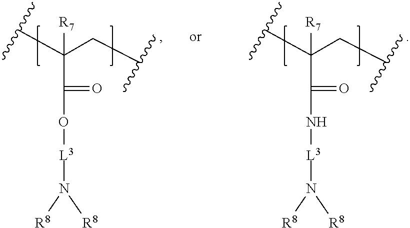

The variable R⁷ can be chosen from —H and a substituted or unsubstituted (C₁-C₅)alkyl group. The variable R⁷ can be methyl. At each occurrence, R⁸ can be independently chosen from —H and substituted or unsubstituted (C₁-C₂₀)hydrocarbyl-NR⁹² interrupted by 0, 1, 2, or 3 groups independently chosen from —O—, —S—, substituted or unsubstituted —NH—, —(O—(C₁-C₁₀)hydrocarbylene)ₙ-, and —(NR⁹—(C₁-C₁₀)hydrocarbylene)ₙ-. At each occurrence, R⁸ can be independently (C₁-C₁₀)alkyl. The variable R⁸ can be ethyl. At each occurrence, R⁹ can be independently chosen from —H, substituted or unsubstituted (C₁-C₂₀)hydrocarbyl, and —((C₁-C₁₀)hydrocarbylene-NR⁵)ₙ—. The variable L³ can be a substituted or unsubstituted (C₁-C₂₀)hydrocarbylene. At each occurrence, n can be independently about 1 to about 10,000, about 1 to about 1,000, or about 1, 2, 3, 4, 5, 6, 8, 10, 15, 20, 25, 30, 40, 50, 60, 70, 80, 90, 100, 125, 150, 175, 200, 225, 250, 500, 750, 1,000, 1,500, 2,000, 2,500, 5,000, or about 10,000 or more. The variable L³ can be (C₁-C₁₀)alkylene. The variable L³ can be ethylene. In some embodiments, R⁷ can be chosen from —H and a substituted or unsubstituted (C₁-C₅)alkyl group, L³ can be (C₁-C₁₀)alkylene, and R⁵ can be independently (C₁-C₁₀)alkyl. The compound including the amino group can include the structure:

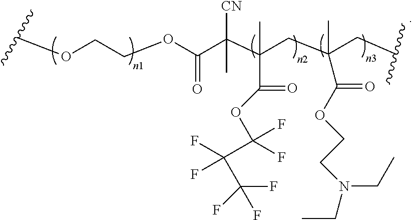

The variables n1, n2, and n3 are independently about 1 to about 10,000, about 1 to about 1,000, or about 1, 2, 3, 4, 5, 6, 8, 10, 15, 20, 25, 30, 40, 50, 60, 70, 80, 90, 100, 125, 150, 175, 200, 225, 250, 500, 750, 1,000, 1,500, 2,000, 2,500, 5,000, or about 10,000 or more. The compound including the amino group can have the structure:

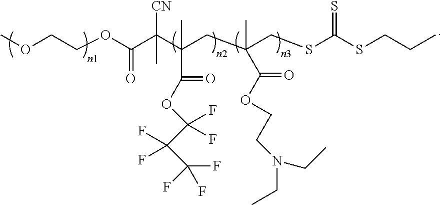

The compound including the amino group can have the structure:

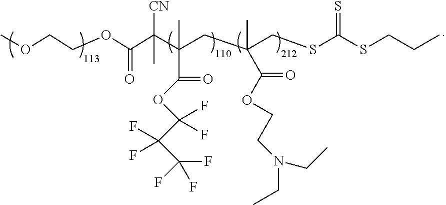

### Nanomaterial.

In various embodiments, the aqueous composition can include a nanomaterial. The aqueous composition can include one nanomaterial, or more than one nanomaterial. In some embodiments, the aqueous composition can be free of nanomaterials. The nanomaterial can be any suitable nanomaterial. In some embodiments, the nanomaterial is a nanoparticle.

In some embodiments, the nanomaterial can affect various properties of the aqueous composition by interacting with the compound including at least one secondary or tertiary amine, such as by forming a double network comprised of micellar entanglements and particle junctions. In some embodiments, the nanomaterial can enhance the thermal stability of the aqueous composition, allowing the composition to maintain an enhanced viscosity at higher temperatures. In some embodiments, during use of the composition, the nanoparticle can form a bridge, avoiding or reducing leaf-off into the formation.

The nanomaterial can form any suitable proportion of the aqueous composition. For example, the nanomaterial can be about 0.01 wt % to about 50 wt % of the composition, about 0.01 wt % to about 10 wt % of the composition, about 0.01 wt % or less, about 0.1 wt %, 1, 2, 3, 4, 5, 6, 8, 10, 12, 14, 15, 20, 25, 30, 35, 40, 45, or about 50 wt % or more of the composition.

The nanomaterial can have any suitable size. In some embodiments, the nanomaterial has a largest dimension of about 0.01 nm to about 999 nm, about 1 nm to about 100 nm, about 0.01 nm, 0.1, 1, 2, 3, 4, 5, 10, 15, 20, 30, 40, 50, 60, 70, 80, 90, 100, 125, 150, 175, 200, 225, 250, 300, 400, 500, 600, 700, 800, 900, or about 999 nm.

The nanomaterial can include or be formed from any suitable material, such as at least one of an alkali earth metal oxide, an alkali earth metal hydroxide, an alkali metal oxide, an alkali metal hydroxide, a transition metal oxide, a transition metal hydroxide, a post-transition metal oxide, and a post-transition metal hydroxide. The nanomaterial can include or be formed from at least one of ZnO, berlinite (APO₄), lithium tantalate (LiTaO₃), gallium orthophosphate (GaPO₄), BaTiO₃, SrTiO₃, PbZrTiO₃, KNbO₃, LiNbO₃, LiTaO₃, BiFeO₃, sodium tungstate, Ba₂NaNb₅O₅, Pb₂KNb₅O₁₅, potassium sodium tartrate, tourmaline, topaz, silica.

### Surfactant.

The aqueous composition can include one or more surfactants. The surfactant can facilitate the coating of the curable components of the composition on proppant, gravel, or a subterranean surface causing the curable components to flow to the contact points between adjacent proppant particles. The surfactant can be any suitable surfactant, such that the composition can be used as described herein. In some embodiments, the compound including the protonated or carboxylated amine group can bridge multiple molecules of the surfactant and thereby increase the viscosity of the aqueous composition. The surfactant can form any suitable proportion of the aqueous composition, such that the composition can be used as described herein. For example, about 0.000.1 wt % to about 20 wt % of the composition can be the one or more surfactants, about 0.001 wt % to about 1 wt %, or about 0.000.1 wt % or less, or about 0.001 wt %, 0.005, 0.01, 0.02, 0.04, 0.06, 0.08, 0.1, 0.2, 0.3, 0.4, 0.5, 0.6, 0.8, 1, 2, 3, 4, 5, 6, 7, 8, 9, 10, 11, 12, 13, 14, 15, 16, 17, 18, 19, or about 20 wt % or more.

In some embodiments, the surfactant is at least one of a cationic surfactant, an anionic surfactant, and a non-ionic surfactant. In some embodiments, the ionic groups of the surfactant can include counterions, such that the overall charge of the ionic groups is neutral, whereas in other embodiments, no counterion can be present for one or more ionic groups, such that the overall charge of the one or more ionic groups is not neutral.

In one example, the surfactant can be a non-ionic surfactant. Examples of non-ionic surfactants can include polyoxyethylene alkyl ethers, polyoxyethylene alkylphenol ethers, polyoxyethylene lauryl ethers, polyoxyethylene sorbitan monoleates, polyoxyethylene alkyl esters, polyoxyethylene sorbitan alkyl esters, polyethylene glycol, polypropylene glycol, diethylene glycol, ethoxylated trimethylnonanols, polyoxyalkylene glycol modified polysiloxane surfactants, and mixtures, copolymers or reaction products thereof. In one example, the surfactant is polyglycol-modified trimethylsilylated silicate surfactant. Examples of suitable non-ionic surfactants can include, but are not limited to, condensates of ethylene oxide with long chain fatty alcohols or fatty acids such as a (C₁₂₋₁₆)alcohol, condensates of ethylene oxide with an amine or an amide, condensation products of ethylene and propylene oxide, esters of glycerol, sucrose, sorbitol, fatty acid alkylol amides, sucrose esters, fluoro-surfactants, fatty amine oxides, polyoxyalkylene alkyl ethers such as polyethylene glycol long chain alkyl ether, polyoxyalkylene sorbitan ethers, polyoxyalkylene alkoxylate esters, polyoxyalkylene alkylphenol ethers, ethylene glycol propylene glycol copolymers and alkylpolysaccharides, polymeric surfactants such as polyvinyl alcohol (PVA) and polyvinylmethylether. In certain embodiments, the surfactant is a polyoxyethylene fatty alcohol or mixture of polyoxyethylene fatty alcohols. In other embodiments, the surfactant is an aqueous dispersion of a polyoxyethylene fatty alcohol or mixture of polyoxyethylene fatty alcohols. In some examples, suitable non-ionic surfactants can include at least one of an alkyl polyglycoside, a sorbitan ester, a methyl glucoside ester, an amine ethoxylate, a diamine ethoxylate, a polyglycerol ester, an alkyl ethoxylate, an alcohol that has been at least one of polypropoxylated and polyethoxylated, any derivative thereof, or any combination thereof.

Examples of suitable anionic surfactants can include, but are not limited to, alkyl sulphates such as lauryl sulphate, polymers such as acrylates/C₁₀₋₃₀ alkyl acrylate crosspolymer alkylbenzenesulfonic acids and salts such as hexylbenzenesulfonic acid, octylbenzenesulfonic acid, decylbenzenesulfonic acid, dodecylbenzenesulfonic acid, cetylbenzenesulfonic acid and myristylbenzenesulfonic acid; the sulphate esters of monoalkyl polyoxyethylene ethers; alkylnapthylsulfonic acid; alkali metal sulfoccinates, sulfonated glyceryl esters of fatty acids such as sulfonated monoglycerides of coconut oil acids, salts of sulfonated monovalent alcohol esters, amides of amino sulfonic acids, sulfonated products of fatty acid nitriles, sulfonated aromatic hydrocarbons, condensation products of naphthalene sulfonic acids with formaldehyde, sodium octahydroanthracene sulfonate, alkali metal alkyl sulphates, ester sulphates, and alkarylsulfonates. Anionic surfactants can include alkali metal soaps of higher fatty acids, alkylaryl sulfonates such as sodium dodecyl benzene sulfonate, long chain fatty alcohol sulfates, olefin sulfates and olefin sulfonates, sulfated monoglycerides, sulfated esters, sulfonated ethoxylated alcohols, sulfosuccinates, alkane sulfonates, phosphate esters, alkyl isethionates, alkyl taurates, and alkyl sarcosinates.

Suitable cationic surfactants can include at least one of an arginine methyl ester, an alkanolamine, an alkylenediamide, an alkyl ester sulfonate, an alkyl ether sulfonate, an alkyl ether sulfate, an alkali metal alkyl sulfate, an alkyl or alkylaryl sulfonate, a sulfosuccinate, an alkyl or alkylaryl disulfonate, an alkyl disulfate, an alcohol polypropoxylated or polyethoxylated sulfates, a taurate, an amine oxide, an alkylamine oxide, an ethoxylated amide, an alkoxylated fatty acid, an alkoxylated alcohol, an ethoxylated fatty amine, an ethoxylated alkyl amine, a betaine, a modified betaine, an alkylamidobetaine, a quaternary ammonium compound, any derivative thereof, and any combination thereof. Examples of suitable cationic surfactants can include quaternary ammonium hydroxides such as octyl trimethyl ammonium hydroxide, dodecyl trimethyl ammonium hydroxide, hexadecyl trimethyl ammonium hydroxide, octyl dimethyl benzyl ammonium hydroxide, decyl dimethyl benzyl ammonium hydroxide, didodecyl dimethyl ammonium hydroxide, dioctadecyl dimethyl ammonium hydroxide, tallow trimethyl ammonium hydroxide and coco trimethyl ammonium hydroxide as well as corresponding salts of these materials, fatty amines and fatty acid amides and their derivatives, basic pyridinium compounds, and quaternary ammonium bases of benzimidazolines and poly(ethoxylated/propoxylated) amines.

In some embodiments, the surfactant can be selected from Tergitol™ 15-s-3, Tergitol™ 15-s-40, sorbitan monooleate, polyglycol-modified trimethsilylated silicate, polyglycol-modified siloxanes, polyglycol-modified silicas, ethoxylated quaternary ammonium salt solutions, cetyltrimethylammonium chloride or bromide solutions, an ethoxylated nonyl phenol phosphate ester, and a (C₁₂-C₂₂)alkyl phosphonate. In some examples, the surfactant can be a sulfonate methyl ester, a hydrolyzed keratin, a polyoxyethylene sorbitan monopalmitate, a polyoxyethylene sorbitan monostearate, a polyoxyethylene sorbitan monooleate, a linear alcohol alkoxylate, an alkyl ether sulfate, dodecylbenzene sulfonic acid, a linear nonyl-phenol, dioxane, ethylene oxide, polyethylene glycol, an ethoxylated castor oil, dipalmitoyl-phosphatidylcholine, sodium 4-(1′ heptylnonyl)benzenesulfonate, polyoxyethylene nonyl phenyl ether, sodium dioctyl sulphosuccinate, tetraethyleneglycoldodecylether, sodium octlylbenzenesulfonate, sodium hexadecyl sulfate, sodium laureth sulfate, decylamine oxide, dodecylamine betaine, dodecylamine oxide, N,N,N-trimethyl-1-octadecammonium chloride, xylenesulfonate and salts thereof (e.g., sodium xylene sulfonate), sodium dodecyl sulfate, cetyltrimethylammonium bromide, any derivative thereof, or any combination thereof. The surfactant can be at least one of alkyl propoxy-ethoxysulfonate, alkyl propoxy-ethoxysulfate, alkylaryl-propoxy-ethoxysulfonate, a mixture of an ammonium salt of an alkyl ether sulfate, cocoamidopropyl betaine, cocoamidopropyl dimethylamine oxide, an ethoxylated alcohol ether sulfate, an alkyl or alkene amidopropyl betaine, an alkyl or alkene dimethylamine oxide, an alpha-olefinic sulfonate surfactant, any derivative thereof, and any combination thereof. Suitable surfactants may also include polymeric surfactants, block copolymer surfactants, di-block polymer surfactants, hydrophobically modified surfactants, fluoro-surfactants, and surfactants containing a non-ionic spacer-arm central extension and an ionic or nonionic polar group. In some examples, the non-ionic spacer-arm central extension can be the result of at least one of polypropoxylation and polyethoxylation.

In various embodiments, the surfactant is at least one of a substituted or unsubstituted (C₅-C₅₀)hydrocarbylsulfate salt, a substituted or unsubstituted (C₅-C₅₀)hydrocarbylsulfate (C₁-C₂₀)hydrocarbyl ester wherein the (C₁-C₂₀)hydrocarbyl is substituted or unsubstituted, and a substituted or unsubstituted (C₅-C₅₀)hydrocarbylbisulfate. The surfactant can be at least one of a (C₅-C₂₀)alkylsulfate salt, a (C₅-C₂₀)alkylsulfate (C₁-C₂₀)alkyl ester and a (C₅-C₂₀)alkylbisulfate. In various embodiments the surfactant is a (C₅-C₁₅)alkylsulfate salt, wherein the counterion can be any suitable counterion, such as Na⁺, K⁺, Li⁺, H⁺, Zn⁺, NH₄⁺, Ca²⁺, Mg²⁺, Zn²⁺, or Al³⁺. In some embodiments, the surfactant is a (C₅-C₁₅)alkylsulfate salt sodium salt. In some embodiments, the surfactant is sodium dodecyl sulfate.

In various embodiments, the surfactant is a (C₅-C₅₀)hydrocarbyltri((C₁-C₅₀)hydrocarbyl)ammonium salt, wherein each (C₅-C₅₀)hydrocarbyl is independently selected. The counterion can be any suitable counterion, such as Na⁺, K⁺, Li⁺, H⁺, Zn⁺, NH₄, Ca²⁺, Mg²⁺, Zn²⁺, or Al³⁺. The surfactant can be a (C₅-C₅₀)alkyltri((C₁-C₂₀)alkyl)ammonium salt, wherein each (C₅-C₅₀)alkyl is independently selected. The surfactant can be a (C₁₀-C₃₀)alkyltri((C₁-C₁₀)alkyl)ammonium halide salt, wherein each (C₁₀-C₃₀)alkyl is independently selected. The surfactant can be cetyltrimethylammonium bromide.

### Other Components.

The aqueous composition including the compound including at least one secondary or tertiary amine group, or a mixture including the composition, can include any suitable additional component in any suitable proportion, such that the compound including at least one secondary or tertiary amine group, composition, or mixture including the same, can be used as described herein.

In some embodiments, the composition includes one or more viscosifiers. The viscosifier can be any suitable viscosifier. The viscosifier can affect the viscosity of the composition or a solvent that contacts the composition at any suitable time and location. In some embodiments, the viscosifier provides an increased viscosity at least one of before injection into the subterranean formation, at the time of injection into the subterranean formation, during travel through a tubular disposed in a borehole, once the composition reaches a particular subterranean location, or some period of time after the composition reaches a particular subterranean location. In some embodiments, the viscosifier can be about 0.000.1 wt % to about 10 wt % of the composition or a mixture including the same, about 0.004 wt % to about 0.01 wt %, or about 0.000.1 wt % or less, 0.000.5 wt %, 0.001, 0.005, 0.01, 0.05, 0.1, 0.5, 1, 2, 3, 4, 5, 6, 7, 8, 9, or about 10 wt % or more of the composition or a mixture including the same.

The viscosifier can include at least one of a substituted or unsubstituted polysaccharide, and a substituted or unsubstituted polyalkene (e.g., a polyethylene, wherein the ethylene unit is substituted or unsubstituted, derived from the corresponding substituted or unsubstituted ethene), wherein the polysaccharide or polyalkene is crosslinked or uncrosslinked. The viscosifier can include a polymer including at least one repeating unit derived from a monomer selected from the group consisting of ethylene glycol, acrylamide, vinyl acetate, 2-acrylamidomethylpropane sulfonic acid or its salts, trimethylammoniumethyl acrylate halide, and trimethylammoniumethyl methacrylate halide. The viscosifier can include a crosslinked gel or a crosslinkable gel. The viscosifier can include at least one of a linear polysaccharide, and a poly((C₂-C₁₀)alkene), wherein the (C₂-C₁₀)alkene is substituted or unsubstituted. The viscosifier can include at least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), alginate, chitosan, curdlan, dextran, derivatized dextran, emulsan, a galactoglucopolysaccharide, gellan, glucuronan, N-acetyl-glucosamine, N-acetyl-heparosan, hyaluronic acid, kefiran, lentinan, levan, mauran, pullulan, scleroglucan, schizophyllan, stewartan, succinoglycan, xanthan, diutan, welan, starch, derivatized starch, tamarind, tragacanth, guar gum, derivatized guar gum (e.g., hydroxypropyl guar, carboxy methyl guar, or carboxymethyl hydroxypropyl guar), gum ghatti, gum arabic, locust bean gum, cellulose, and derivatized cellulose (e.g., carboxymethyl cellulose, hydroxyethyl cellulose, carboxymethyl hydroxyethyl cellulose, hydroxypropyl cellulose, or methyl hydroxy ethyl cellulose).

In some embodiments, the viscosifier can include at least one of a poly(vinyl alcohol) homopolymer, poly(vinyl alcohol) copolymer, a crosslinked poly(vinyl alcohol) homopolymer, and a crosslinked poly(vinyl alcohol) copolymer. The viscosifier can include a poly(vinyl alcohol) copolymer or a crosslinked poly(vinyl alcohol) copolymer including at least one of a graft, linear, branched, block, and random copolymer of vinyl alcohol and at least one of a substituted or unsubstituted (C₂-C₅₀)hydrocarbyl having at least one aliphatic unsaturated C—C bond therein, and a substituted or unsubstituted (C₂-C₅₀)alkene. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl phosphonic acid, vinylidene diphosphonic acid, substituted or unsubstituted 2-acrylamido-2-methylpropanesulfonic acid, a substituted or unsubstituted (C₁-C₂₀)alkenoic acid, propenoic acid, butenoic acid, pentenoic acid, hexenoic acid, octenoic acid, nonenoic acid, decenoic acid, acrylic acid, methacrylic acid, hydroxypropyl acrylic acid, acrylamide, fumaric acid, methacrylic acid, hydroxypropyl acrylic acid, vinyl phosphonic acid, vinylidene diphosphonic acid, itaconic acid, crotonic acid, mesoconic acid, citraconic acid, styrene sulfonic acid, allyl sulfonic acid, methallyl sulfonic acid, vinyl sulfonic acid, and a substituted or unsubstituted (C₁-C₂₀)alkyl ester thereof. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl acetate, vinyl propanoate, vinyl butanoate, vinyl pentanoate, vinyl hexanoate, vinyl 2-methyl butanoate, vinyl 3-ethylpentanoate, and vinyl 3-ethylhexanoate, maleic anhydride, a substituted or unsubstituted (C₁-C₂₀)alkenoic substituted or unsubstituted (C₁-C₂₀)alkanoic anhydride, a substituted or unsubstituted (C₁-C₂₀)alkenoic substituted or unsubstituted (C₁-C₂₀)alkenoic anhydride, propenoic acid anhydride, butenoic acid anhydride, pentenoic acid anhydride, hexenoic acid anhydride, octenoic acid anhydride, nonenoic acid anhydride, decenoic acid anhydride, acrylic acid anhydride, fumaric acid anhydride, methacrylic acid anhydride, hydroxypropyl acrylic acid anhydride, vinyl phosphonic acid anhydride, vinylidene diphosphonic acid anhydride, itaconic acid anhydride, crotonic acid anhydride, mesoconic acid anhydride, citraconic acid anhydride, styrene sulfonic acid anhydride, allyl sulfonic acid anhydride, methallyl sulfonic acid anhydride, vinyl sulfonic acid anhydride, and an N—(C₁-C₁₀)alkenyl nitrogen containing substituted or unsubstituted (C₁-C₁₀)heterocycle. The viscosifier can include a poly(vinyl alcohol) copolymer or a crosslinked poly(vinyl alcohol) copolymer including at least one of a graft, linear, branched, block, and random copolymer that includes a poly(vinylalcohol/acrylamide) copolymer, a poly(vinylalcohol/2-acrylamido-2-methylpropanesulfonic acid) copolymer, a poly (acrylamide/2-acrylamido-2-methylpropanesulfonic acid) copolymer, or a poly(vinylalcohol/N-vinylpyrrolidone) copolymer. The viscosifier can include a crosslinked poly(vinyl alcohol) homopolymer or copolymer including a crosslinker including at least one of chromium, aluminum, antimony, zirconium, titanium, calcium, boron, iron, silicon, copper, zinc, magnesium, and an ion thereof. The viscosifier can include a crosslinked poly(vinyl alcohol) homopolymer or copolymer including a crosslinker including at least one of an aldehyde, an aldehyde-forming compound, a carboxylic acid or an ester thereof, a sulfonic acid or an ester thereof, a phosphonic acid or an ester thereof, an acid anhydride, and an epihalohydrin.

In various embodiments, the composition can include one or more crosslinkers. The crosslinker can be any suitable crosslinker. In some examples, the crosslinker can be incorporated in a crosslinked viscosifier, and in other examples, the crosslinker can crosslink a crosslinkable material (e.g., downhole). The crosslinker can include at least one of chromium, aluminum, antimony, zirconium, titanium, calcium, boron, iron, silicon, copper, zinc, magnesium, and an ion thereof. The crosslinker can include at least one of boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, titanium acetylacetonate, aluminum lactate, and aluminum citrate. In some embodiments, the crosslinker can be a (C₁-C₂₀)alkylenebiacrylamide (e.g., methylenebisacrylamide), a poly((C₁-C₂₀)alkenyl)-substituted mono- or poly-(C₁-C₂₀)alkyl ether (e.g., pentaerythritol allyl ether), and a poly(C₂-C₂₀)alkenylbenzene (e.g., divinylbenzene). In some embodiments, the crosslinker can be at least one of alkyl diacrylate, ethylene glycol diacrylate, ethylene glycol dimethacrylate, polyethylene glycol diacrylate, polyethylene glycol dimethacrylate, ethoxylated bisphenol A diacrylate, ethoxylated bisphenol A dimethacrylate, ethoxylated trimethylol propane triacrylate, ethoxylated trimethylol propane trimethacrylate, ethoxylated glyceryl triacrylate, ethoxylated glyceryl trimethacrylate, ethoxylated pentaerythritol tetraacrylate, ethoxylated pentaerythritol tetramethacrylate, ethoxylated dipentaerythritol hexaacrylate, polyglyceryl monoethylene oxide polyacrylate, polyglyceryl polyethylene glycol polyacrylate, dipentaerythritol hexaacrylate, dipentaerythritol hexamethacrylate, neopentyl glycol diacrylate, neopentyl glycol dimethacrylate, pentaerythritol triacrylate, pentaerythritol trimethacrylate, trimethylol propane triacrylate, trimethylol propane trimethacrylate, tricyclodecane dimethanol diacrylate, tricyclodecane dimethanol dimethacrylate, 1,6-hexanediol diacrylate, and 1,6-hexanediol dimethacrylate. The crosslinker can be about 0.000.01 wt % to about 5 wt % of the composition or a mixture including the same, about 0.001 wt % to about 0.01 wt %, or about 0.000.01 wt % or less, or about 0.000.05 wt %, 0.000,1, 0.000,5, 0.001, 0.005, 0.01, 0.05, 0.1, 0.5, 1, 2, 3, 4, or about 5 wt % or more.

In some embodiments, the composition can include one or more breakers. The breaker can be any suitable breaker, such that the surrounding fluid (e.g., a fracturing fluid) can be at least partially broken for more complete and more efficient recovery thereof, such as at the conclusion of the hydraulic fracturing treatment. In some embodiments, the breaker can be encapsulated or otherwise formulated to give a delayed-release or a time-release of the breaker, such that the surrounding liquid can remain viscous for a suitable amount of time prior to breaking. The breaker can be any suitable breaker; for example, the breaker can be a compound that includes at least one of a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a chloride, fluoride, bromide, phosphate, or sulfate ion. In some examples, the breaker can be an oxidative breaker or an enzymatic breaker. An oxidative breaker can be at least one of a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a persulfate, percarbonate, perborate, peroxide, perphosphosphate, permanganate, chlorite, or hypochlorite ion. An enzymatic breaker can be at least one of an alpha or beta amylase, amyloglucosidase, oligoglucosidase, invertase, maltase, cellulase, hemi-cellulase, and mannanohydrolase. The breaker can be about 0.001 wt % to about 30 wt % of the composition or a mixture including the same, or about 0.01 wt % to about 5 wt %, or about 0.001 wt % or less, or about 0.005 wt %, 0.01, 0.05, 0.1, 0.5, 1, 2, 3, 4, 5, 6, 8, 10, 12, 14, 16, 18, 20, 22, 24, 26, 28, or about 30 wt % or more.

The composition, or a mixture including the composition, can include any suitable fluid. For example, the fluid can be at least one of crude oil, dipropylene glycol methyl ether, dipropylene glycol dimethyl ether, dipropylene glycol methyl ether, dipropylene glycol dimethyl ether, dimethyl formamide, diethylene glycol methyl ether, ethylene glycol butyl ether, diethylene glycol butyl ether, butylglycidyl ether, propylene carbonate, D-limonene, a C₂-C₄₀ fatty acid C₁-C₁₀ alkyl ester (e.g., a fatty acid methyl ester), tetrahydrofurfuryl methacrylate, tetrahydrofurfuryl acrylate, 2-butoxy ethanol, butyl acetate, butyl lactate, furfuryl acetate, dimethyl sulfoxide, dimethyl formamide, a petroleum distillation product of fraction (e.g., diesel, kerosene, napthas, and the like) mineral oil, a hydrocarbon oil, a hydrocarbon including an aromatic carbon-carbon bond (e.g., benzene, toluene), a hydrocarbon including an alpha olefin, xylenes, an ionic liquid, methyl ethyl ketone, an ester of oxalic, maleic or succinic acid, methanol, ethanol, propanol (iso- or normal-), butyl alcohol (iso-, tert-, or normal-), an aliphatic hydrocarbon (e.g., cyclohexanone, hexane), water, brine, produced water, flowback water, brackish water, and sea water. The fluid can form about 0.001 wt % to about 99.999 wt % of the composition, or a mixture including the same, or about 0.001 wt % or less, 0.01 wt %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt % or more.

The aqueous composition including the compound including at least one secondary or tertiary amine group or a mixture including the same can include any suitable downhole fluid. The composition including the compound including at least one secondary or tertiary amine group can be combined with any suitable downhole fluid before, during, or after the placement of the composition in the subterranean formation or the contacting of the composition and the subterranean material. In some examples, the composition including the compound including at least one secondary or tertiary amine group is combined with a downhole fluid above the surface, and then the combined composition is placed in a subterranean formation or contacted with a subterranean material. In another example, the composition including the compound including at least one secondary or tertiary amine group is injected into a subterranean formation to combine with a downhole fluid, and the combined composition is contacted with a subterranean material or is considered to be placed in the subterranean formation. The placement of the composition in the subterranean formation can include contacting the subterranean material and the mixture. Any suitable weight percent of the composition or of a mixture including the same that is placed in the subterranean formation or contacted with the subterranean material can be the downhole fluid, such as about 0.001 wt % to about 99.999 wt %, about 0.01 wt % to about 99.99 wt %, about 0.1 wt % to about 99.9 wt %, about 20 wt % to about 90 wt %, or about 0.001 wt % or less, or about 0.01 wt %, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99 wt %, or about 99.999 wt % or more of the composition or mixture including the same.

In some embodiments, the composition, or a mixture including the same, can include any suitable amount of any suitable material used in a downhole fluid. For example, the composition or a mixture including the same can include water, saline, aqueous base, acid, oil, organic solvent, synthetic fluid oil phase, aqueous solution, alcohol or polyol, cellulose, starch, alkalinity control agents, acidity control agents, density control agents, density modifiers, emulsifiers, dispersants, polymeric stabilizers, crosslinking agents, polyacrylamide, a polymer or combination of polymers, antioxidants, heat stabilizers, foam control agents, solvents, diluents, plasticizer, filler or inorganic particle, pigment, dye, precipitating agent, oil-wetting agents, set retarding additives, surfactants, gases, weight reducing additives, heavy-weight additives, lost circulation materials, filtration control additives, salts (e.g., any suitable salt, such as potassium salts such as potassium chloride, potassium bromide, potassium formate; calcium salts such as calcium chloride, calcium bromide, calcium formate; cesium salts such as cesium chloride, cesium bromide, cesium formate, or a combination thereof), fibers, thixotropic additives, breakers, crosslinkers, rheology modifiers, curing accelerators, curing retarders, pH modifiers, chelating agents, scale inhibitors, enzymes, resins, water control materials, oxidizers, markers, Portland cement, pozzolana cement, gypsum cement, high alumina content cement, slag cement, silica cement, fly ash, metakaolin, shale, zeolite, a crystalline silica compound, amorphous silica, hydratable clays, microspheres, lime, or a combination thereof. In various embodiments, the composition or a mixture including the same can include one or more additive components such as: COLDTROL®, ATC®, OMC 2™, and OMC 42™ thinner additives; RHEMOD™ viscosifier and suspension agent; TEMPERUS™ and VIS-PLUS® additives for providing temporary increased viscosity; TAU-MOD™ viscosifying/suspension agent; ADAPTA®, DURATONE® HT, THERMO TONE™, BDF™-366, and BDF™-454 filtration control agents; LIQUITONE™ polymeric filtration agent and viscosifier; FACTANT™ emulsion stabilizer; LE SUPERMUL™, EZ MUL® NT, and FORTI-MUL® emulsifiers; DRIL TREAT® oil wetting agent for heavy fluids; AQUATONE-S™ wetting agent; BARACARB® bridging agent; BAROID® weighting agent; BAROLIFT® hole sweeping agent; SWEEP-WATE® sweep weighting agent; BDF-508 rheology modifier; and GELTONE® II organophilic clay. In various embodiments, the composition or a mixture including the same can include one or more additive components such as: X-TEND® II, PAC™-R, PAC™-L, LIQUI-VIS® EP, BRINEDRIL-VIS™, BARAZAN®, N-VIS®, and AQUAGEL® viscosifiers; THERMA-CHEK®, N-DRIL™, N-DRIL™ HT PLUS, IMPERMEX®, FILTERCHEK™, DEXTRID®, CARBONOX®, and BARANEX® filtration control agents; PERFORMATROL®, GEM™, EZ-MUD®, CLAY GRABBER®, CLAYSEAL®, CRYSTAL-DRIL®, and CLAY SYNC™ II shale stabilizers; NXS-LUBE™, EP MUDLUBE®, and DRIL-N-SLIDE™ lubricants; QUIK-THIN®, IRON-THIN™, THERMA-THIN®, and ENVIRO-THIN™ thinners; SOURSCAV™ scavenger; BARACOR® corrosion inhibitor; and WALL-NUT®, SWEEP-WATE®, STOPPIT™, PLUG-GIT®, BARACARB®, DUO-SQUEEZE®, BAROFIBRE™, STEELSEAL®, and HYDRO-PLUG® lost circulation management materials. Any suitable proportion of the composition or mixture including the composition can include any optional component listed in this paragraph, such as about 0.001 wt % to about 99.999 wt %, about 0.01 wt % to about 99.99 wt %, about 0.1 wt % to about 99.9 wt %, about 20 to about 90 wt %, or about 0.001 wt % or less, or about 0.01 wt %, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99 wt %, or about 99.999 wt % or more of the composition or mixture.

In various embodiments, the composition or mixture can include a proppant, a resin-coated proppant, an encapsulated resin, or a combination thereof. A proppant is a material that keeps an induced hydraulic fracture at least partially open during or after a fracturing treatment. Proppants can be transported into the subterranean formation (e.g., downhole) to the fracture using fluid, such as fracturing fluid or another fluid. A higher-viscosity fluid can more effectively transport proppants to a desired location in a fracture, especially larger proppants, by more effectively keeping proppants in a suspended state within the fluid. Examples of proppants can include sand, gravel, glass beads, polymer beads, ground products from shells and seeds such as walnut hulls, and manmade materials such as ceramic proppant, bauxite, tetrafluoroethylene materials (e.g., TEFLON™ polytetrafluoroethylene), fruit pit materials, processed wood, composite particulates prepared from a binder and fine grade particulates such as silica, alumina, fumed silica, carbon black, graphite, mica, titanium dioxide, meta-silicate, calcium silicate, kaolin, talc, zirconia, boron, fly ash, hollow glass microspheres, and solid glass, or mixtures thereof. In some embodiments, the proppant can have an average particle size, wherein particle size is the largest dimension of a particle, of about 0.001 mm to about 3 mm, about 0.15 mm to about 2.5 mm, about 0.25 mm to about 0.43 mm, about 0.43 mm to about 0.85 mm, about 0.85 mm to about 1.18 mm, about 1.18 mm to about 1.70 mm, or about 1.70 to about 2.36 mm. In some embodiments, the proppant can have a distribution of particle sizes clustering around multiple averages, such as one, two, three, or four different average particle sizes. The composition or mixture can include any suitable amount of proppant, such as about 0.01 wt % to about 99.99 wt %, about 0.1 wt % to about 80 wt %, about 10 wt % to about 60 wt %, or about 0.01 wt % or less, or about 0.1 wt %, 1, 2, 3, 4, 5, 10, 15, 20, 30, 40, 50, 60, 70, 80, 85, 90, 91, 92, 93, 94, 95, 96, 97, 98, 99, about 99.9 wt %, or about 99.99 wt % or more.

### System or Apparatus.

In various embodiments, the present invention provides a system. The system can be any suitable system that can use or that can be generated by use of an embodiment of the composition described herein in a subterranean formation, or that can perform or be generated by performance of a method for using the composition described herein. The system can include an aqueous composition including the compound including at least one secondary or tertiary amine group. The system can also include a subterranean formation including the composition therein. In some embodiments, the composition in the system can also include a downhole fluid, or the system can include a mixture of the composition and downhole fluid. In some embodiments, the system can include a tubular, and a pump configured to pump the composition into the subterranean formation through the tubular.

Various embodiments provide systems and apparatus configured for delivering the composition described herein to a subterranean location and for using the composition therein, such as for a gravel packing operation, or a fracturing operation (e.g., pre-pad, pad, slurry, or finishing stages). In various embodiments, the system or apparatus can include a pump fluidly coupled to a tubular (e.g., any suitable type of oilfield pipe, such as pipeline, drill pipe, production tubing, and the like), with the tubular containing a composition including the compound including at least one secondary or tertiary amine group described herein.

The pump can be a high pressure pump in some embodiments. As used herein, the term “high pressure pump” will refer to a pump that is capable of delivering a fluid to a subterranean formation (e.g., downhole) at a pressure of about 1000 psi or greater. A high pressure pump can be used when it is desired to introduce the composition to a subterranean formation at or above a fracture gradient of the subterranean formation, but it can also be used in cases where fracturing is not desired. In some embodiments, the high pressure pump can be capable of fluidly conveying particulate matter, such as proppant particulates, into the subterranean formation. Suitable high pressure pumps will be known to one having ordinary skill in the art and can include floating piston pumps and positive displacement pumps.

In other embodiments, the pump can be a low pressure pump. As used herein, the term “low pressure pump” will refer to a pump that operates at a pressure of about 1000 psi or less. In some embodiments, a low pressure pump can be fluidly coupled to a high pressure pump that is fluidly coupled to the tubular. That is, in such embodiments, the low pressure pump can be configured to convey the composition to the high pressure pump. In such embodiments, the low pressure pump can “step up” the pressure of the composition before it reaches the high pressure pump.

In some embodiments, the systems or apparatuses described herein can further include a mixing tank that is upstream of the pump and in which the composition is formulated. In various embodiments, the pump (e.g., a low pressure pump, a high pressure pump, or a combination thereof) can convey the composition from the mixing tank or other source of the composition to the tubular. In other embodiments, however, the composition can be formulated offsite and transported to a worksite, in which case the composition can be introduced to the tubular via the pump directly from its shipping container (e.g., a truck, a railcar, a barge, or the like) or from a transport pipeline. In either case, the composition can be drawn into the pump, elevated to an appropriate pressure, and then introduced into the tubular for delivery to the subterranean formation.

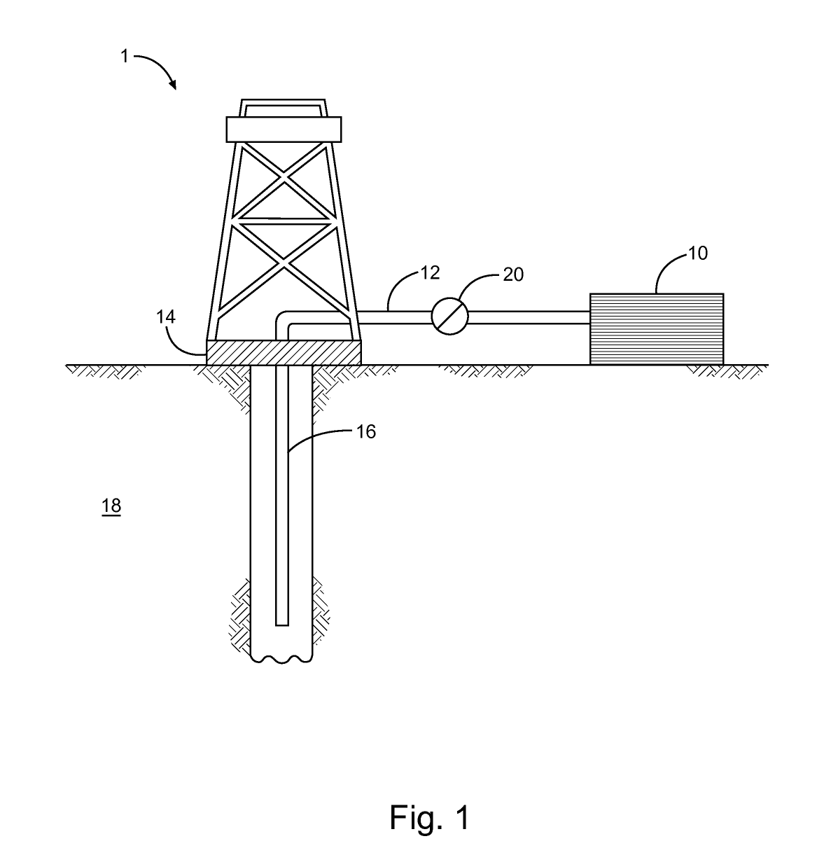

FIG. 1 shows an illustrative schematic of systems and apparatuses that can deliver embodiments of the compositions of the present invention to a subterranean location, according to one or more embodiments. It should be noted that while FIG. 1 generally depicts a land-based system or apparatus, it is to be recognized that like systems and apparatuses can be operated in subsea locations as well. Embodiments of the present invention can have a different scale than that depicted in FIG. 1. As depicted in FIG. 1, system or apparatus 1 can include mixing tank 10, in which an embodiment of the composition can be formulated. The composition can be conveyed via line 12 to wellhead 14, where the composition enters tubular 16, with tubular 16 extending from wellhead 14 into subterranean formation 18. Upon being ejected from tubular 16, the composition can subsequently penetrate into subterranean formation 18. Pump 20 can be configured to raise the pressure of the composition to a desired degree before its introduction into tubular 16. It is to be recognized that system or apparatus 1 is merely exemplary in nature and various additional components can be present that have not necessarily been depicted in FIG. 1 in the interest of clarity. In some examples, additional components that can be present include supply hoppers, valves, condensers, adapters, joints, gauges, sensors, compressors, pressure controllers, pressure sensors, flow rate controllers, flow rate sensors, temperature sensors, and the like.

Although not depicted in FIG. 1, at least part of the composition can, in some embodiments, flow back to wellhead 14 and exit subterranean formation 18. The composition that flows back can be substantially diminished in the concentration of the compound including the at least one amine group therein. In some embodiments, the composition that has flowed back to wellhead 14 can subsequently be recovered, and in some examples reformulated, and recirculated to subterranean formation 18.

It is also to be recognized that the disclosed composition can also directly or indirectly affect the various downhole or subterranean equipment and tools that can come into contact with the composition during operation. Such equipment and tools can include wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, and the like), logging tools and related telemetry equipment, actuators (e.g., electromechanical devices, hydromechanical devices, and the like), sliding sleeves, production sleeves, plugs, screens, filters, flow control devices (e.g., inflow control devices, autonomous inflow control devices, outflow control devices, and the like), couplings (e.g., electro-hydraulic wet connect, dry connect, inductive coupler, and the like), control lines (e.g., electrical, fiber optic, hydraulic, and the like), surveillance lines, drill bits and reamers, sensors or distributed sensors, downhole heat exchangers, valves and corresponding actuation devices, tool seals, packers, cement plugs, bridge plugs, and other wellbore isolation devices or components, and the like. Any of these components can be included in the systems and apparatuses generally described above and depicted in FIG. 1.

### Composition for Treatment of a Subterranean Formation.

Various embodiments provide an aqueous composition for treatment of a subterranean formation. The aqueous composition can be any suitable composition that can be used to perform an embodiment of the method for treatment of a subterranean formation described herein. For example, the composition can include a compound including at least one secondary or tertiary amine group, such as any compound including at least one secondary or tertiary amine group described herein. In some embodiments, the composition can also include a nanomaterial.

In some embodiments, the composition further includes a downhole fluid. The downhole fluid can be any suitable downhole fluid. In some embodiments, the downhole fluid is a composition for fracturing of a subterranean formation or subterranean material, or a fracturing fluid. In some embodiments, the composition is a fracturing fluid, or a gravel packing fluid.

In some embodiments, the compound including at least one secondary or tertiary amine group satisfies at least one of Condition (A), (B), and (C). In Condition (A), the compound including the amine can have the structure:

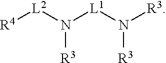

In condition (A), at least one of Conditions (A1), (A2), and (A3) can be satisfied. In Condition (A1), L¹ can be —(C₁-C₁₀)alkylene-, L² can be a bond, R³ can be (C₁-C₁₀)hydrocarbyl, and R⁴ can be R³. In Condition (A2), L¹ can be —(C₁-C₁₀)alkylene-, L² can be (C₁-C₁₀)hydrocarbylene-(NR²—(C₁-C₁₀)hydrocarbylene)ₙ-, at each occurrence n can be independently about 1 to about 10, at each occurrence R³ can be chosen from —H and (C₁-C₁₀)hydrocarbyl, and R⁴ can be (C₅-C₉₀)alkyl interrupted by 0, 1, 2, or 3 ethenylene groups. In Condition (A3), L¹ can be —C(O)—(C₁-C₉)alkyl-, L² can be a bond, R³ can be (C₁-C₁₀)hydrocarbyl, and R⁴ can be (C₅-C₉₀)alkyl interrupted by 0, 1, 2, or 3 alkenylene groups. In Condition (B) the compound including the amine has the structure:

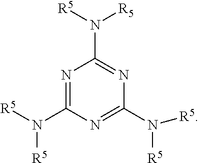

At each occurrence R⁵ can be independently chosen from —H, (C₁-C₂₀)alkyl, and (C₁-C₂₀)alkyl-NR⁶₂. Each R⁵-substituted amino group can have at least one R⁵ that is H. At each occurrence R⁶ can be independently (C₁-C₂₀)alkyl. In Condition (C), the compound including the at least one secondary or tertiary amine can be a polymer including at least one repeating group that includes at least one of the one or more secondary or tertiary amines, the repeating group having the structure:

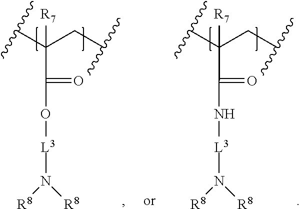

The variable R⁷ can be chosen from —H and a substituted or unsubstituted (C₁-C₅)alkyl group. The variable L³ can be (C₁-C₁₀)alkylene. The variable R⁵ can be independently (C₁-C₁₀)alkyl. In some embodiments, the composition can also include a nanomaterial.

### Method for Preparing a Composition for Treatment of a Subterranean Formation.

In various embodiments, the present invention provides a method for preparing a composition for treatment of a subterranean formation. The method can be any suitable method that produces a composition described herein. For example, the method can include forming a aqueous composition including a compound including at least one secondary or tertiary amine group, such as any suitable compound including at least one secondary or tertiary amine group described herein.

### EXAMPLES

Various embodiments of the present invention can be better understood by reference to the following Examples which are offered by way of illustration. The present invention is not limited to the Examples given herein.

### Example 1. N,N,N′,N′-Tetramethyl-1,3-Propanediamine (TMPDA) and Sodium Dodecyl Sulfate (SDS)

This Example is based on Yongmin Zhang, Yujun Feng, Yuejiao Wang, and Xiangliang Li Langmuir 2013 Apr. 2 29(13):4187-92.

Sample Preparation. A concentrated stock solution was prepared by dissolving 500 mmol of SDS and 250 mmol of TMPDA in 1 L of distilled water, followed by magnetic agitation for several minutes (to get SDS-TMPDA). Lower-concentration samples were obtained by diluting the stock solution with distilled water. All of the samples were fixed at the same molar ratio of 2:1 SDS/TMPDA unless otherwise stated. The concentrations of the solutions are given as the concentration of TMPDA.

CO₂ was bubbled into SDS-TMPDA solutions at ambient temperature with a fixed flow rate of 0.1 L·min⁻¹ for 3 min under a pressure of 0.1 MPa, leading to a transparent viscoelastic fluid (referred to as SDS-TMPDA-CO2). After that, the sample was kept in a sealed vessel to avoid contact with air. To remove CO₂ efficiently, N₂ was bubbled into the SDS-TMPDA-CO2 solution at 75° C. at the same flow rate as for CO₂ until equilibrium was attained, resulting in a low viscosity waterlike solution. All of the samples that were obtained were kept at 25° C. for about 24 h prior to the measurements.

Rheology. Rheological measurements were performed on a Physica MCR 301 (Anton Paar, Austria) rotational rheometer equipped with CC27 (ISO3219) concentric cylinder geometry with a measuring bob radius of 13.33 mm and a measuring cup radius of 14.46 mm. Samples were equilibrated at 25° C. for no less than 20 min prior to the experiments. Dynamic frequency spectra were conducted in the linear viscoelastic region, as determined from prior dynamic stress-sweep measurements. All measurements were carried out in stress-controlled mode, and Cannon standard oil was used to calibrate the instrument before the measurements. The temperature was controlled by a Peltier device, and a solvent trap was used to minimize water evaporation during the measurements.

Surface Tension Measurement. The surface tension (γ) was measured with a Kriss K100 tensiometer by the automatic model of the du Noüy ring technique at 25±0.01° C., and a cover was used to minimize water evaporation. A set of measurements to obtain equilibrium surface tension were made until the change was less than 0.03 mN·m⁻¹ every 3 min.

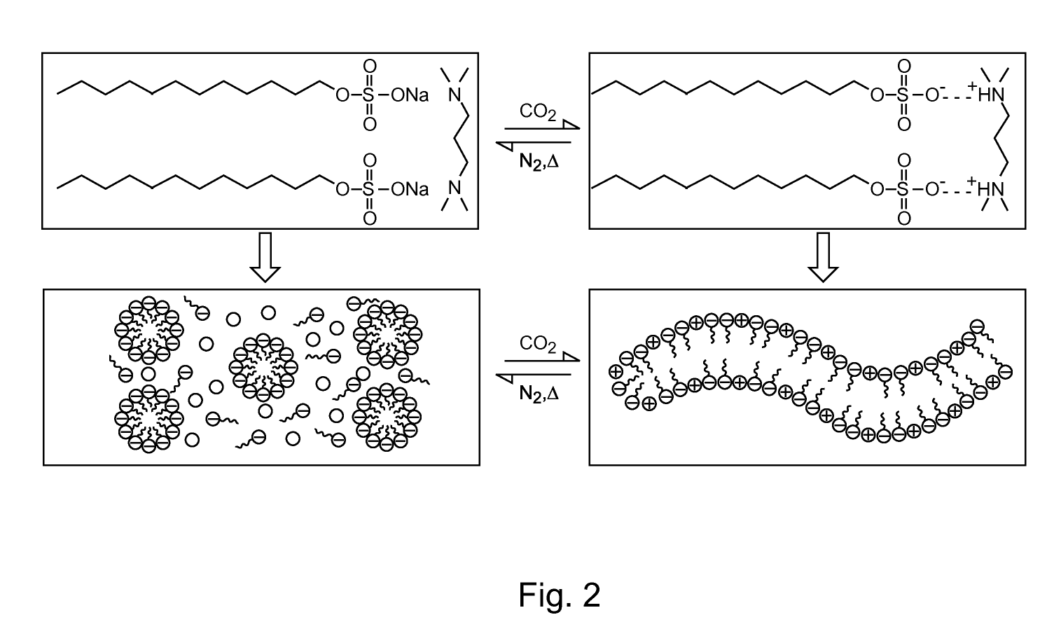

When CO₂ is bubbled into an aqueous mixture of these reactants, the TMPDA molecules are protonated to form quaternary ammonium species, two of which in the same protonated TMPDA molecule “bridge” two SDS molecules by noncovalent electrostatic attraction, behaving like a pseudogemini surfactant and forming viscoelastic worm-like micelles (WLMs). Upon removal of CO₂, the quaternized spacers are deprotonated back to tertiary amines, dissociating the pseudogeminis back to conventional SDS molecules that form low-viscosity spherical micelles. FIG. 2 illustrates the switching mechanism of the TMPDA-SDS system.

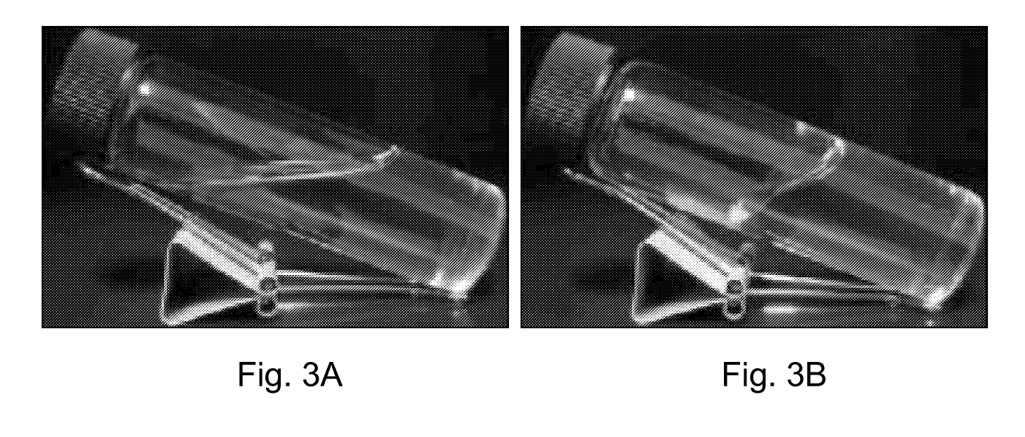

As exhibited in FIG. 3, the 250 mM SDS-TMPDA aqueous solution has low viscosity (FIG. 3A); however, the viscosity increases after sparging CO₂ (SDS-TMPDA-CO₂, FIG. 3B). Both steady and dynamic rheological measurements were performed for quantitative characterization.

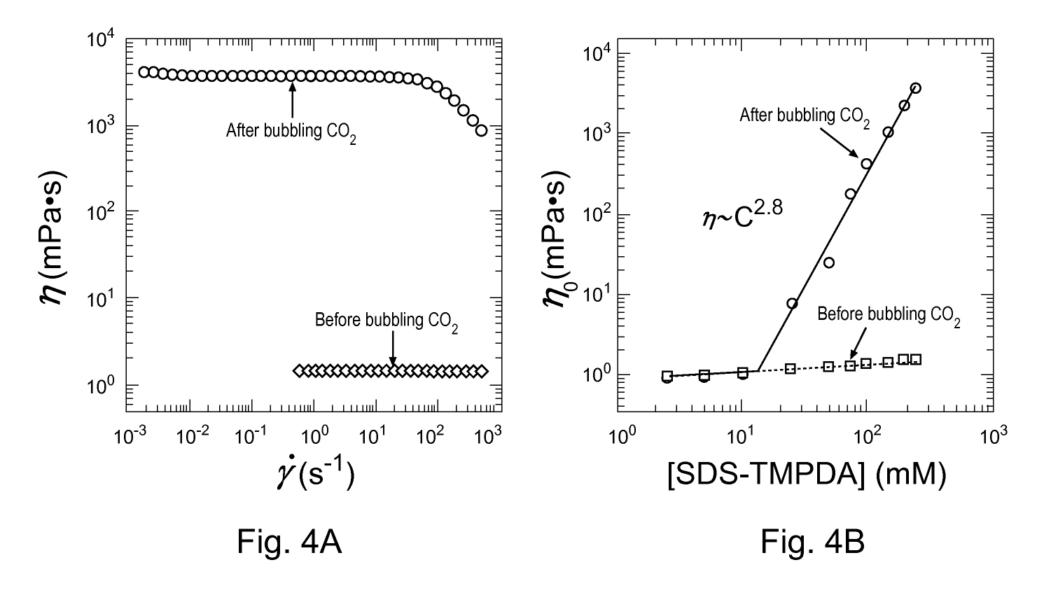

Compared in FIG. 4A are the flow curves of the 250 mM aqueous solution before and after bubbling CO₂. In the absence of CO₂, the viscosity remains at 1.5 mPa·s with little change regardless of the shear rate (e.g., typical Newtonian fluid behavior). After CO₂ is bubbled, the viscosity curve moves upward and is divided into two parts: a flat segment at around 4000 mPa·s within the shear-rate range of 10⁻³ to 50 s⁻¹ and a shear-thinning section between 50 and 500 s⁻¹. Such shear thinning behavior of surfactant solutions is normally interpreted as the presence of entangled WLMs. The extrapolation of viscosity to zero-shear rate in the Newtonian plateau yields the zero-shear viscosity, η₀. Before CO₂ is bubbled, the η₀−C curve (FIG. 4B) of the solution shows no change over the whole concentration range whereas after CO₂ sparging it is divided into two parts with a clear break point (e.g., a critical overlapping concentration C* (˜13 mM)). In the dilute regime (C<C*), the average micellar length usually increases with surfactant concentration following a simple power-law model with an exponent of ˜(½)¹⁸ and η₀ increases linearly in accordance with Einstein equation η₀=η_{water}(1+KC),¹⁸ where K is on the order of unity; in the semidilute region (C>C*), WLMs are formed and start entangling with each other, forming a dynamic transient network and imparting a substantial viscosity enhancement to the solutions. In this case, η₀ increases exponentially by several orders of magnitude following the scaling law η₀∝C^{P} where p is the power-law index and is found to be 2.8 for the SDS−=TMPDA solution, close to the theoretical prediction (˜2.5) for branched worms.

### Example 2. Melamine and Melamine Derivatives

This Example is based on Hongyao Yin, Yujun Feng, Hanbin Liu, Meng Mu, and Chenhong Fei Langmuir 2014, 30, 9911-9919.

This Example describes switchable melamine and melamine derivatives. Melamine is a typical cyclic organobase bearing an s-triazine ring along with three primary amines evenly distributed.

Synthesis. The compounds 2, 4, and 5 were prepared by using 2-chloro-4,6-diamino-1,3,5-trazine to react with methylamine, 2-(dimethylamino)ethylamine, and 3-(dimethylamino)propylamine, respectively; 3, 6, and 7 were obtained in a similar manner but with cyanuric chloride as the starting material instead.

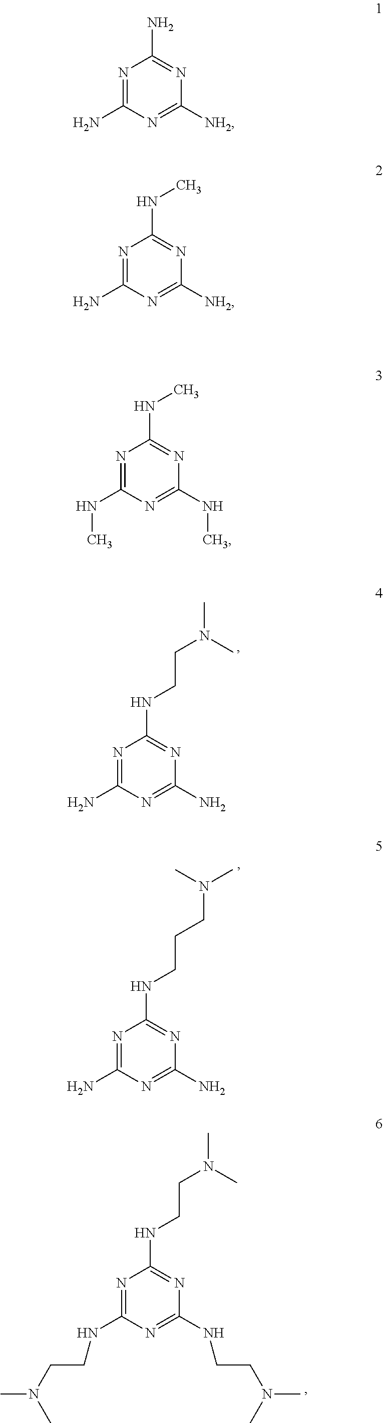

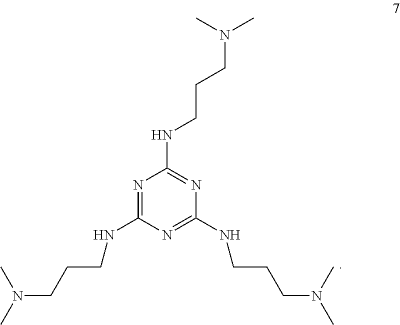

### Example 3. Octadecyl Dipropylene Triamine (ODPTA)

This Example is based on Yongmin Zhang, Yujun Feng, Jiyu Wanga Shuai He, Zanru Guo, Zonglin Chua and C'ecile A. Dreiss Chem. Commun., 2013, 49, 4902.

A long-chain surfactant was synthesized, octadecyl dipropylene triamine (ODPTA), whose polyamine headgroup responds to the stimulus of CO₂, and the C18-tailed hydrocarbon chain is amenable to spontaneous assembly into WLMs, as shown in the following scheme:

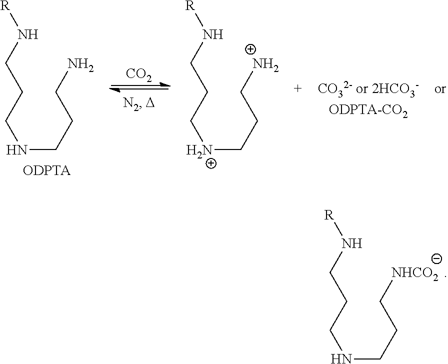

A 2.0 wt % ODPTA dispersion is milky and of low-viscosity at ambient temperature, but instantaneously switches to a transparent viscoelastic “gel” after 2 min of CO₂ bubbling (“ODPTA-CO₂”), characteristically trapping bubbles over a long period of time. After displacing CO₂ with N₂ at 75° C. for about 45 min, the “gel” regains its initial appearance. Use of HCl instead to regulate the pH to ˜6.0 (the equilibrium value reached by “ODPTC-CO₂”) yields a transparent, water-like fluid, with none of the viscoelastic characteristics of “ODPTC-CO₂”.

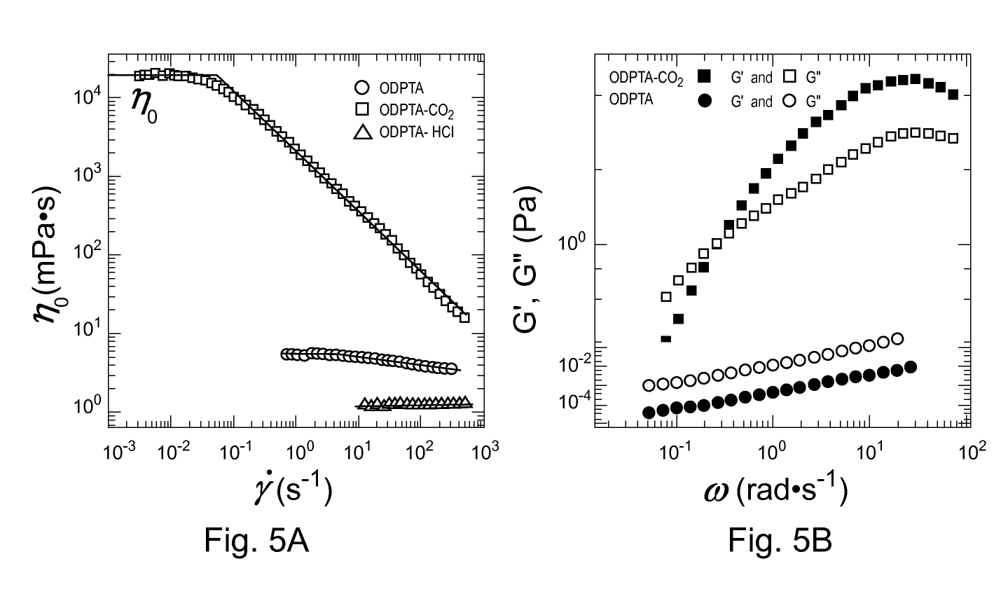

Steady-state and dynamic rheological measurements substantiate these visual observations. In the absence of CO₂, the ODPTA aqueous dispersions show a weak shear-thinning response, with a maximum viscosity of only 5 mPa s (FIG. 5A). Exposure to CO₂ shifts the flow curve upwards, and the dispersions become shear-thinning with a much higher zero-shear viscosity (η₀˜20 000 mPa s), a behavior characteristic of WLMs. A clear break in a double-logarithm scale of the no-concentration (C) plot corresponds to the overlapping concentration C* (B0.13 wt %), separating the dilute and semi-dilute regimes. For C<C*, the average micellar length usually increases with C following a simple power-law model with an exponent of ˜½, and η₀ increases linearly in accordance with the Einstein equation η₀=η_{water}(1+KC) where K is of the order of unity. For C>C*, the WLMs start to become entangled, forming a dynamic transient network and imparting substantial viscoelasticity to the solutions, following the scaling law η₀∝C^{3.3} (very close to the theoretical exponent of 3.5). When adjusting the pH of ODPTA dispersions with HCl to that of “ODPTA-CO₂,” the dispersions display typical Newtonian behavior with a viscosity value as low as 1 mPa s.

Oscillatory shear measurements (FIG. 5B) also corroborate the formation and breaking of ODPTA WLMs. The dependence of the storage (G′) and loss (G″) modulus with frequency shows liquid-like behavior in the absence of CO₂ (G″>G′), while bubbling CO₂ induces a predominantly solid-like viscoelastic response, with G′ above G″ over a large range of frequencies.

The CO₂-switch imparts full reversibility to the process and reproducibility over several cycles. Alternatively bubbling CO₂ and replacing with N₂ with heating at 75° C. for 45 min switches η₀ from 5 mPa s to 20 000 mPa s, without any alteration of the response over 4 cycles.

### Example 4. N-Erucamidopropyl-N,N-Dimethylamine (EPDM)

This Example is based on Yongmin Zhang, Zonglin Chu, C'ecile A. Dreiss, Yuejiao Wangc Chenhong Fei and Yujun Feng Soft Matter, 2013, 9, 6217.

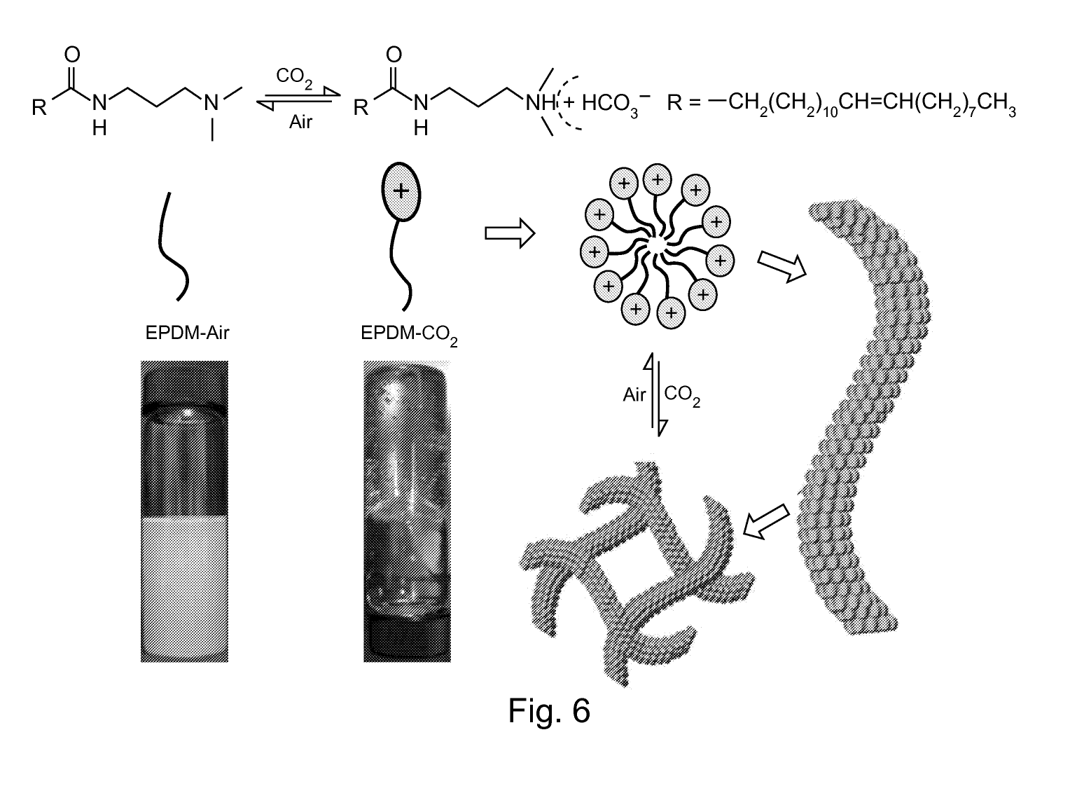

This Example describes WLMs that are switched back and forth by CO₂ and air at room temperature, without the use of either heat or an inert gas. The viscoelastic aqueous phase includes the surfactant N-erucamidopropyl-N,N-dimethylamine (EPDM, FIG. 6) and CO₂, without introducing any hydrotropes that are normally needed in conventional WLMs to promote the growth of micelles through screening electrostatic repulsions between the charged surfactant headgroups or strong binding with surfactants. The low-viscosity cloudy solutions can be re-obtained simply by bubbling or exposing to air at room temperature.

As exhibited in FIG. 6, the original 100 mM EPDM aqueous solution looks like an emulsion with low viscosity, but converts into a transparent viscoelastic “gel” (“EPDM-CO2”) just after 1 minute of CO₂ streaming at a low rate of 0.1 L min⁻¹ at room temperature, and the low-viscosity cloudy solution (“EPDM-air”) can be attained again upon further bubbling air under the same conditions.

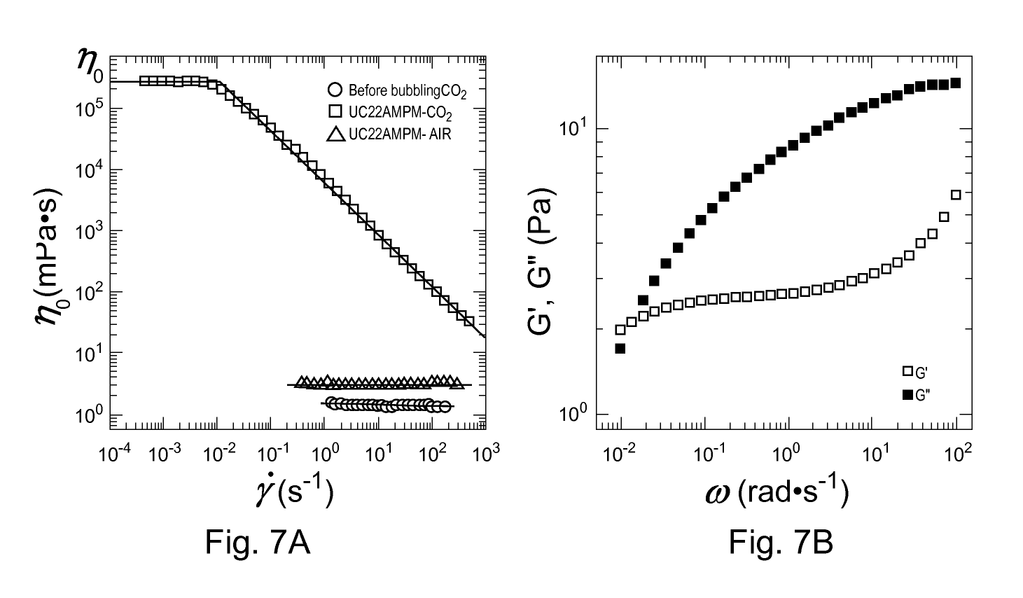

Such a CO₂-air responsiveness of the system was further examined by steady-state and oscillatory rheological measurements. As shown in FIG. 7A, EPDM-CO₂ presents clear shear-thinning behavior when the shear rate exceeds a critical shear rate, indicating the presence of WLMs in the solutions that undergo structural change (alignment of the long micelles at high shear rates). The zero-shear viscosity (η₀), obtained by extrapolating the Newtonian plateau to zero-shear rate, is as high as 300 000 mPa s, or 105 times higher than that before bubbling CO₂. If we plot η₀ against the concentration (C) of EPDM-CO₂, one can clearly find two parts in the η₀−C curve with a clear turning point of C* (˜6 mM). When C<C*, the average micellar length usually increases with the surfactant concentration following a simple power-law model with an exponent of ˜½, and η₀ increases linearly in accordance with the Einstein equation η₀=η_{water}(1+KC), where K is on the order of unity; when C>C*, the WLMs develop and start entangling with each other, forming a dynamic transient network and imparting substantial viscosity enhancement to the solutions. In this case, η₀ increases exponentially by several orders of magnitude following the scaling law η₀∝Cⁿ, where n is the power-law index and is found to be 4.0 for the EPDM-CO₂, which is close to the value of 3.5 predicted by the theoretical model and the value of 3.79 reported for 3-(N-erucamidopropyl-N,N-dimethyl ammonium)propane sulfonate (EDAS).

The oscillatory data (FIG. 7B) confirm that the storage modulus (G′) dominates the loss modulus (G″) over a wide range of frequencies (above ω_{c}˜0.011 rad s⁻¹), indicative of a typical viscoelastic fluid. The plateau modulus (G₀), taken here as the storage modulus at high shear frequency, is ˜15 Pa and the maximum relaxation time (τ_{R}, inverse of ω_{c}) is as long as ˜15 s. EPDM solutions, both before bubbling CO₂ and after bubbling air (FIG. 7A), are typical Newtonian fluids with a constant viscosity of ˜3 and 1 mPa s, respectively, and their moduli are near zero (beyond the detection limit of the instrument). When plotting G₀ and τ_{R} versus C for EPDM-CO₂, one can find that the latter increases continuously until C reaches around 150 mM, while the former still follows the scaling law as G₀∝C^{m} with scaling index m being 2.0, which is very close to the corresponding theoretical forecast value of 2.25.

### Example 5. Triblock Copolymer

This Example is based on Han bin Liu, Ying Zhao, C'ecile A. Dreiss and Yujun Feng Soft Matter, 2014, 10, 6387.

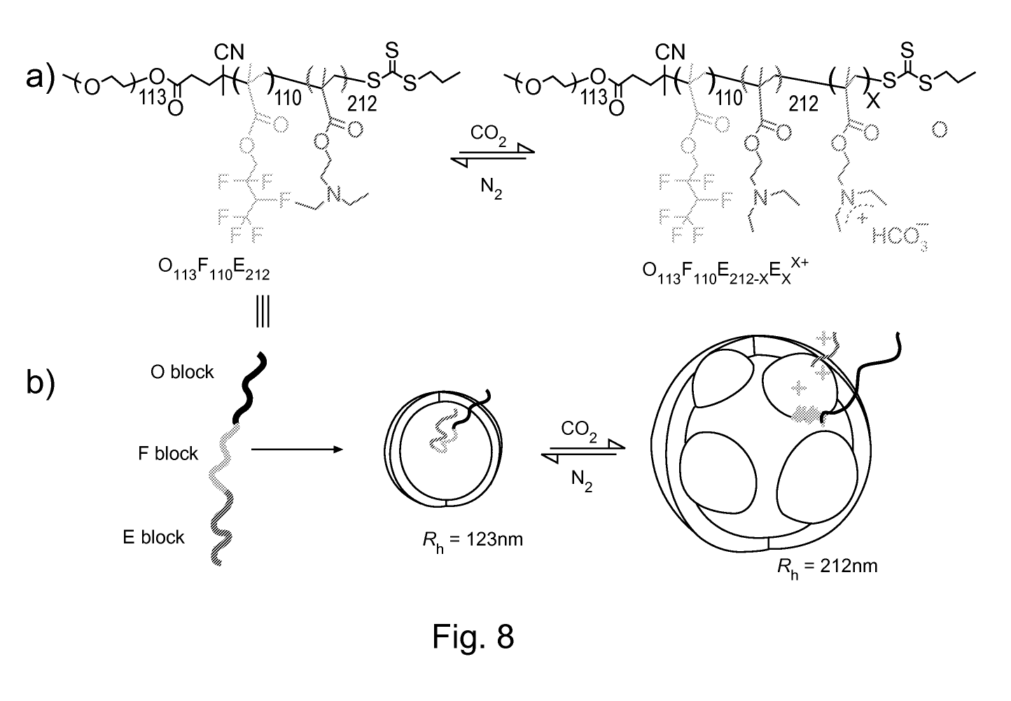

This Example describes a CO₂-responsive multi-compartment micelle (MCM) with a segregated corona made from a linear ABC triblock copolymer composed of poly(ethylene oxide) (O), poly(2,2,3,4,4,4-hexafluorobutyl methacrylate) (F), and poly-(2-(diethylamino)ethyl methacrylate) (E) (FIG. 8). The water-soluble block “O” stabilizes the micelles in aqueous solution by forming a hydrophilic corona. The fluorinated block “F” is designed to compartmentalize the micellar core into segregated microdomains, because of the well-known incompatibility between hydro- and fluorocarbons. The hydrocarbon segment, “E,” has CO₂-sensitivity.

A triblock copolymer O₁₁₃F₁₁₀E₂₁₂ was prepared by a two-step reversible addition-fragmentation chain transfer (RAFT) polymerization using a polyethylene oxide (PEO)-containing chain transfer agent. After purification, the copolymer was dissolved in N,N-dimethylformamide (DMF) and dialyzed against deionized water to obtain the aqueous micellar solution.

FIG. 8 illustrates the molecular structure of the triblock copolymer O₁₁₃F₁₁₀E₂₁₂ (a) and a schematic representation of the micellar morphology after sequentially bubbling and removing CO₂ (b); triblock copolymer (bottom left); spherical micelle with corona formed by the hydrophilic “O” block and core formed by hydrophobic “E” and “F” blocks (bottom center); MCMs with a core formed by the “F” block and phase-separated corona, including a plurality of darker spheres representing charged “E” domains and corona formed by the “O” domains (bottom right).

The CO₂-responsiveness was first confirmed by monitoring the conductivity and pH during successive CO₂ and N₂ bubbling cycles (FIG. 8). Upon CO₂ bubbling, the conductivity of the micellar solution rapidly rises from 22.5 to 56.4 μS cm⁻¹ and then gradually increases to the equilibrium value of 62.4 μS cm⁻¹. Concurrently, the pH drops from 7.51 to 4.81. Upon N₂ bubbling, CO₂ depletes from the solution, and the conductivity decreases to 27.4 μS cm⁻¹, while the pH recovers back to 7.20. These variations are remarkably reversible and can be repeated for three cycles without alteration. Further, this trigger benefits from the easy removal of the unstable bicarbonate salt that is produced by the reaction of CO₂ with the tertiary amine groups in the “E” block, thus making it truly reversible, and therefore superior to the more traditional pH trigger (obtained by successive additions of acid and base), where reversibility is affected by the accumulation of by-products.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Embodiment 1 provides a method of treating a subterranean formation, the method comprising:

placing in a subterranean formation an aqueous composition comprising
a compound comprising at least one secondary or tertiary amine group; and

bubbling a gas comprising CO₂ through the aqueous composition sufficient to protonate or carboxylate the amine group and increase the viscosity of the aqueous composition.

Embodiment 2 provides the method of Embodiment 1, wherein the method further comprises obtaining or providing the composition, wherein the obtaining or providing of the composition occurs above-surface.

Embodiment 3 provides the method of any one of Embodiments 1-2, wherein the method further comprises obtaining or providing the composition, wherein the obtaining or providing of the composition occurs in the subterranean formation.

Embodiment 4 provides the method of any one of Embodiments 1-3, wherein the bubbling of the gas comprising CO₂ is performed at least one of before, after, and during the placing.

Embodiment 5 provides the method of any one of Embodiments 1-4, further comprising at least one of fracturing the subterranean formation and gravel packing the subterranean formation with the aqueous composition.

Embodiment 6 provides the method of any one of Embodiments 1-5, wherein the bubbling of the gas comprising CO₂ through the aqueous composition is performed before placing the aqueous composition in the subterranean formation.

Embodiment 7 provides the method of any one of Embodiments 1-6, wherein the bubbling of the gas comprising CO₂ through the aqueous composition is performed at least one of during and after placing the aqueous composition in the subterranean formation.

Embodiment 8 provides the method of any one of Embodiments 1-7, wherein the aqueous composition comprises water that is at least one of fresh water, brine, produced water, flowback water, brackish water, and sea water.

Embodiment 9 provides the method of Embodiment 8, wherein the water in the aqueous composition has a salt concentration of about 5,000 ppm or more.

Embodiment 10 provides the method of any one of Embodiments 1-9, wherein the aqueous composition comprises at least one organic solvent or oil.

Embodiment 11 provides the method of any one of Embodiments 1-10, wherein upon protonation or carboxylation, the compound comprising the protonated or carboxylated amine group forms an aqueous emulsion.

Embodiment 12 provides the method of any one of Embodiments 1-11, wherein upon protonation or carboxylation, the compound comprising the protonated or carboxylated amine group forms a worm-like micelle.

Embodiment 13 provides the method of any one of Embodiments 1-12, wherein the composition further comprises a surfactant.

Embodiment 14 provides the method of Embodiment 13, wherein the surfactant is an anionic surfactant.

Embodiment 15 provides the method of any one of Embodiments 13-14, wherein the compound comprising the protonated or carboxylated amine group bridges multiple molecules of the surfactant.

Embodiment 16 provides the method of any one of Embodiments 1-15, wherein the aqueous composition further comprises at least one nanomaterial.

Embodiment 17 provides the method of Embodiment 16, wherein about 0.01 wt % to about 50 wt % of the composition is the nanomaterial.

Embodiment 18 provides the method of any one of Embodiments 16-17, wherein about 0.01 wt % to about 10 wt % of the composition is the nanomaterial.

Embodiment 19 provides the method of any one of Embodiments 16-18, wherein the nanomaterial is a nanoparticle.

Embodiment 20 provides the method of any one of Embodiments 16-19, wherein the nanomaterial has a largest dimension of about 0.01 nm to about 999 nm.

Embodiment 21 provides the method of any one of Embodiments 16-20, wherein the nanomaterial has a largest dimension of about 1 nm to about 100 nm.

Embodiment 22 provides the method of any one of Embodiments 16-21, wherein the nanomaterial comprises at least one of an alkali earth metal oxide, an alkali earth metal hydroxide, an alkali metal oxide, an alkali metal hydroxide, a transition metal oxide, a transition metal hydroxide, a post-transition metal oxide, and a post-transition metal hydroxide.

Embodiment 23 provides the method of any one of Embodiments 16-22, wherein the nanomaterial comprises at least one of ZnO, berlinite (APO₄), lithium tantalate (LiTaO₃), gallium orthophosphate (GaPO₄), BaTiO₃, SrTiO₃, PbZrTiO₃, KNbO₃, LiNbO₃, LiTaO₃, BiFeO₃, sodium tungstate, Ba₂NaNb₅O₅, Pb₂KNb₅O₁₅, potassium sodium tartrate, tourmaline, topaz, silica.

Embodiment 24 provides the method of any one of Embodiments 1-23, further comprising bubbling a gas comprising at least one of a noble gas, N₂, and air through the composition sufficient to deprotonate or decarboxylate the amine group and decrease the viscosity of the aqueous composition.

Embodiment 25 provides the method of Embodiment 24, wherein the bubbling of the gas sufficient to deprotonate or decarboxylate the amine group is performed after the placing.

Embodiment 26 provides the method of any one of Embodiments 1-25, wherein about 0.01 wt % to about 99 wt % of the aqueous composition is the compound comprising the amine.

Embodiment 27 provides the method of any one of Embodiments 1-26, wherein about 0.01 wt % to about 50 wt % of the aqueous composition is the compound comprising the amine.

Embodiment 28 provides the method of any one of Embodiments 1-27, wherein the compound comprising the amine has the structure:

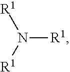

wherein

at each occurrence, R¹ is independently chosen from —H and substituted or unsubstituted (C₁-C₁₀₀)hydrocarbyl optionally interrupted by 0, 1, 2, or 3 groups independently chosen from —O—, —S—, substituted or unsubstituted —NH—, —(O—(C₁-C₁₀)hydrocarbylene)ₙ-, and —(NR²—(C₁-C₁₀)hydrocarbylene)ₙ-,

at each occurrence, R² is independently chosen from —H and —(NR¹—(C₁-C₁₀)hydrocarbylene)ₙ-,

each (C₁-C₁₀)hydrocarbyl is independently substituted or unsubstituted, and

at each occurrence, n is independently about 1 to about 10,000.

Embodiment 29 provides the method of Embodiment 28, wherein

at each occurrence, R¹ is independently chosen from —H and (C₁-C₁₀₀)hydrocarbyl optionally interrupted by 0, 1, 2, or 3 groups independently chosen from —O—, —S—, substituted or unsubstituted —NH—, —(O—(C₁-C₅)alkyl)ₙ-, and —(NR²—(C₁-C₅)alkyl)ₙ-,

at each occurrence, R² is independently chosen from —H and —(NR¹—(C₁-C₅)hydrocarbylene)ₙ-,

each (C₁-C₅)alkyl is independently substituted or unsubstituted, and

at each occurrence, n is independently about 1 to about 1,000.

Embodiment 30 provides the method of any one of Embodiments 28-29, wherein the compound comprising the amine has the structure:

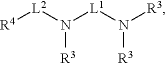

wherein

at each occurrence, R³ is chosen from —H and substituted or unsubstituted (C₁-C₁₀)hydrocarbyl,

at each occurrence, R⁴ is chosen from —R³ and substituted or unsubstituted (C₅-C₁₀₀)hydrocarbyl, and

at each occurrence, L¹ and L² are each independently chosen from a bond, a (C₁-C₁₀)hydrocarbylene, and a (C₁-C₁₀)hydrocarbylene-(NR²—(C₁-C₁₀)hydrocarbylene)ₙ-, wherein each (C₁-C₁₀)hydrocarbylene is independently substituted or unsubstituted.

Embodiment 31 provides the method of Embodiment 30, wherein L¹ is —(C₁-C₁₀)alkylene-.

Embodiment 32 provides the method of any one of Embodiments 30-31, wherein L¹ is -propylene-.

Embodiment 33 provides the method of any one of Embodiments 30-32, wherein L² is a bond.

Embodiment 34 provides the method of any one of Embodiments 30-33, wherein R³ is (C₁-C₁₀)hydrocarbyl.

Embodiment 35 provides the method of any one of Embodiments 30-34, wherein R³ is methyl.

Embodiment 36 provides the method of any one of Embodiments 30-35, wherein R⁴ is R³.

Embodiment 37 provides the method of any one of Embodiments 30-36, wherein R⁴ is methyl.

Embodiment 38 provides the method of any one of Embodiments 30-37, wherein

L¹ is —(C₁-C₁₀)alkylene-,

L² is a bond,

R³ is (C₁-C₁₀)hydrocarbyl, and

R⁴ is R³.

Embodiment 39 provides the method of any one of Embodiments 1-38, wherein the compound comprising the amine group has the structure:

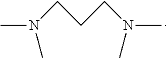

Embodiment 40 provides the method of any one of Embodiments 30-39, wherein L¹ is —(C₁-C₁₀)alkylene-.

Embodiment 41 provides the method of any one of Embodiments 30-40, wherein L¹ is -propylene-.

Embodiment 42 provides the method of any one of Embodiments 30-41, wherein L² is (C₁-C₁₀)hydrocarbylene-(NR²—(C₁-C₁₀)hydrocarbylene)ₙ-.

Embodiment 43 provides the method of any one of Embodiments 30-42, wherein L² is (C₂-C₅)alkylene-(NR²(C₂-C₅)alkylene)ₙ-.

Embodiment 44 provides the method of any one of Embodiments 30-43, wherein at each occurrence, n is independently about 1 to about 10.

Embodiment 45 provides the method of any one of Embodiments 30-44, wherein n is 1.

Embodiment 46 provides the method of any one of Embodiments 30-45, wherein at each occurrence R³ is chosen from —H and (C₁-C₁₀)hydrocarbyl.

Embodiment 47 provides the method of any one of Embodiments 30-46, wherein R³ is —H.

Embodiment 48 provides the method of any one of Embodiments 30-47, wherein R⁴ is (C₅-C₁₀₀)hydrocarbyl.

Embodiment 49 provides the method of any one of Embodiments 30-48, wherein R⁴ is (C₅-C₉₀)alkyl interrupted by 0, 1, 2, or 3 ethenylene groups.

Embodiment 50 provides the method of any one of Embodiments 30-49, wherein R⁴ is a (C₁₈)alkyl.

Embodiment 51 provides the method of any one of Embodiments 30-50, wherein

L¹ is —(C₁-C₁₀)alkylene-,

L² is (C₁-C₁₀)hydrocarbylene-(NR²—(C₁-C₁₀)hydrocarbylene)ₙ-,

at each occurrence, n is independently about 1 to about 10,

at each occurrence R³ is chosen from —H and (C₁-C₁₀)hydrocarbyl, and

R⁴ is (C₅-C₉₀)alkyl interrupted by 0, 1, 2, or 3 ethenylene groups.

Embodiment 52 provides the method of any one of Embodiments 1-51, wherein the compound comprising the amine has the structure:

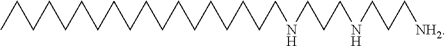 [SMILES: CCCCCCCCCCCCCCCCCCNCCCNCCCN]

Embodiment 53 provides the method of any one of Embodiments 30-52, wherein L¹ is —C(O)—(C₁-C₉)alkyl-.

Embodiment 54 provides the method of any one of Embodiments 30-53, wherein L¹ is —C(O)-propylene-.

Embodiment 55 provides the method of any one of Embodiments 30-54, wherein L² is a bond.

Embodiment 56 provides the method of any one of Embodiments 30-55, wherein R³ is (C₁-C₁₀)hydrocarbyl.

Embodiment 57 provides the method of any one of Embodiments 30-56, wherein R³ is methyl.

Embodiment 58 provides the method of any one of Embodiments 30-57, wherein R⁴ is (C₅-C₁₀₀)hydrocarbyl.

Embodiment 59 provides the method of any one of Embodiments 30-58, wherein R⁴ is (C₅-C₉₀)alkyl interrupted by 0, 1, 2, or 3 alkenylene groups.

Embodiment 60 provides the method of any one of Embodiments 30-59, wherein R⁴ is —(CH₂)₁₁—CH═CH—(CH₂)₇CH₃.

Embodiment 61 provides the method of any one of Embodiments 30-60, wherein

L¹ is —C(O)—(C₁-C₉)alkyl-,

L² is a bond,

R³ is (C₁-C₁₀)hydrocarbyl, and

R⁴ is (C₅-C₉₀)alkyl interrupted by 0, 1, 2, or 3 alkenylene groups.

Embodiment 62 provides the method of any one of Embodiments 1-61, wherein the compound comprising the amino group has the structure:

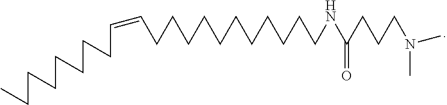 [SMILES: CCCCCCCC/C=C\CCCCCCCCCCCNC(=O)CCCN(C)C]

Embodiment 63 provides the method of any one of Embodiments 1-62, wherein the compound comprising the amine has the structure:

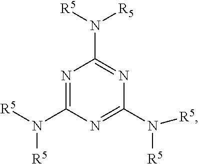

wherein at each occurrence R⁵ is independently chosen from —H and substituted or unsubstituted (C₁-C₂₀)hydrocarbyl-NR⁶₂ interrupted by 0, 1, 2, or 3 groups independently chosen from —O—, —S—, substituted or unsubstituted —NH—, —(O—(C₁-C₁₀)hydrocarbylene)ₙ-, and —(NR⁶—(C₁-C₁₀)hydrocarbylene)ₙ-,

at each occurrence, R⁶ is independently chosen from —H, substituted or unsubstituted (C₁-C₂₀)hydrocarbyl, and —((C₁-C₁₀)hydrocarbylene-NR⁵)ₙ—, each (C₁-C₁₀)hydrocarbyl is independently substituted or unsubstituted, and

at each occurrence, n is independently about 1 to about 10,000.

Embodiment 64 provides the method of Embodiment 63, wherein each R⁵⁻substituted amino group has at least one R⁵ that is H.

Embodiment 65 provides the method of any one of Embodiments 63-64, wherein one R⁵-substituted amino group has two R⁵ that are H.

Embodiment 66 provides the method of any one of Embodiments 63-65, wherein two R⁵-substituted amino groups each have two R⁵ that are H.

Embodiment 67 provides the method of any one of Embodiments 63-66, wherein at each occurrence R⁵ is independently chosen from —H and (C₁-C₂₀)alkyl-NR⁶₂.

Embodiment 68 provides the method of any one of Embodiments 63-67, wherein at each occurrence R⁶ is independently chosen from —H and (C₁-C₂₀)hydrocarbyl.

Embodiment 69 provides the method of any one of Embodiments 63-68, wherein at each occurrence R⁶ is independently chosen from —H and (C₁-C₂₀)alkyl.

Embodiment 70 provides the method of any one of Embodiments 63-69, wherein at each occurrence R⁶ is independently (C₁-C₂₀)alkyl.

Embodiment 71 provides the method of any one of Embodiments 63-70, wherein at each occurrence R⁶ is independently (C₁-C₅)alkyl.

Embodiment 72 provides the method of any one of Embodiments 63-71, wherein at each occurrence R⁵ is independently chosen from —H, (C₁-C₂₀)alkyl, and (C₁-C₂₀)alkyl-NR⁶₂,

each R⁵-substituted amino group has at least one R⁵ that is H, and at each occurrence R⁶ is independently (C₁-C₂₀)alkyl.

Embodiment 73 provides the method of any one of Embodiments 1-72, wherein the compound comprising the amine group has a structure chosen from:

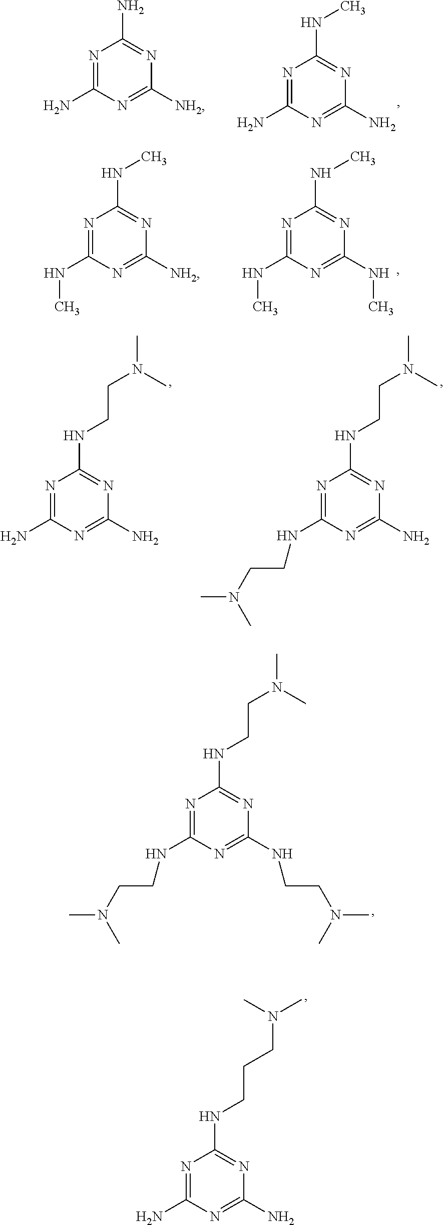

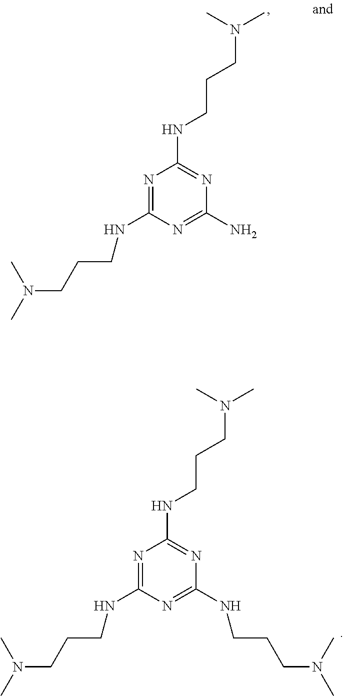

Embodiment 74 provides the method of any one of Embodiments 1-73, wherein the compound comprising the amine is a polymer comprising at least one ethenylene repeating unit that includes the amine group as a substituent thereof, wherein the ethenylene repeating unit is otherwise substituted or unsubstituted.

Embodiment 75 provides the method of Embodiment 74, wherein the amine is bound to the ethenylene repeating unit via a —C(O)—O-L³- group, wherein L³ is a substituted or unsubstituted (C₁-C₂₀)hydrocarbylene.

Embodiment 76 provides the method of any one of Embodiments 1-75, wherein the compound comprising the at least one secondary or tertiary amine is a polymer comprising at least one repeating group that comprises at least one of the one or more secondary or tertiary amines, the repeating group having the structure:

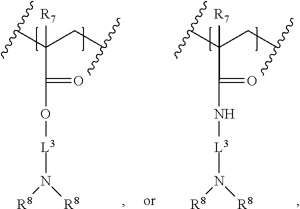

wherein

R⁷ is chosen from —H and a substituted or unsubstituted (C₁-C₅)alkyl group,

at each occurrence, R⁸ is independently chosen from —H and substituted or unsubstituted (C₁-C₂₀)hydrocarbyl-NR⁹₂ interrupted by 0, 1, 2, or 3 groups independently chosen from —O—, —S—, substituted or unsubstituted —NH—, —(O—(C₁-C₁₀)hydrocarbylene)ₙ-, and —(NR⁹—(C₁-C₁₀)hydrocarbylene)ₙ-,

at each occurrence, R⁹ is independently chosen from —H, substituted or unsubstituted (C₁-C₂₀)hydrocarbyl, and —((C₁-C₁₀)hydrocarbylene-NR⁵)ₙ—,

L³ is a substituted or unsubstituted (C₁-C₂₀)hydrocarbylene, and

at each occurrence, n is about 1 to about 10,000.

Embodiment 77 provides the method of Embodiment 76, wherein R⁷ is methyl.

Embodiment 78 provides the method of any one of Embodiments 76-77, wherein L³ is (C₁-C₁₀)alkylene.

Embodiment 79 provides the method of any one of Embodiments 76-78, wherein L³ is ethylene.

Embodiment 80 provides the method of any one of Embodiments 76-79, wherein at each occurrence, R⁸ is independently (C₁-C₁₀)alkyl.

Embodiment 81 provides the method of any one of Embodiments 76-80, wherein R is ethyl.

Embodiment 82 provides the method of any one of Embodiments 76-81, wherein

R⁷ is chosen from —H and a substituted or unsubstituted (C₁-C₅)alkyl group,

L³ is (C₁-C₁₀)alkylene, and

R⁸ is independently (C₁-C₁₀)alkyl.

Embodiment 83 provides the method of any one of Embodiments 74-82, wherein the polymer further comprises a fluoro(C₁-C₁₀)alkyl methacrylate repeating group.

Embodiment 84 provides the method of any one of Embodiments 74-83, wherein the polymer further comprises a fluorobutyl methacrylate repeating group.

Embodiment 85 provides the method of any one of Embodiments 74-84, wherein the polymer further comprises a poly(oxy(C₂-C₅)alkylene) repeating unit.

Embodiment 86 provides the method of any one of Embodiments 74-85, wherein the polymer further comprises a poly(oxyethylene) repeating unit.

Embodiment 87 provides the method of any one of Embodiments 74-86, wherein the polymer further comprises a —O—C(O)—CH₂— unit, wherein the —CH₂— unit is substituted or unsubstituted.

Embodiment 88 provides the method of any one of Embodiments 74-87, wherein the polymer further comprises a —O—C(O)—CR¹⁰₂— unit, wherein at each occurrence R¹⁰ is independently chosen from —H, a substituted or unsubstituted (C1-C₅)alkyl, and a cyano group.

Embodiment 89 provides the method of any one of Embodiments 74-88, wherein the polymer further comprises a —O—C(O)—C(CH₃)(CN)— unit.

Embodiment 90 provides the method of any one of Embodiments 1-89, wherein the compound comprising the amino group comprises the structure:

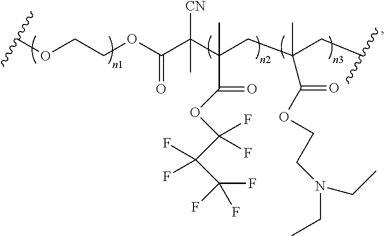

wherein

n1, n2, and n3 are independently about 1 to about 10,000.

Embodiment 91 provides the method of any one of Embodiments 1-90, wherein the compound comprising the amino group has the structure:

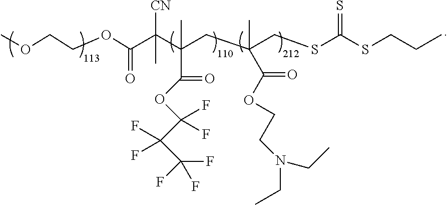

Embodiment 92 provides the method of any one of Embodiments 1-91, further comprising combining the composition with an aqueous or oil-based fluid comprising a stimulation fluid, fracturing fluid, spotting fluid, remedial treatment fluid, acidizing fluid, conformance fluid, pill, packer fluid, logging fluid, or a combination thereof, to form a mixture, wherein the placing the composition in the subterranean formation comprises placing the mixture in the subterranean formation.

Embodiment 93 provides the method of any one of Embodiments 1-92, wherein at least one of prior to, during, and after the placing of the composition in the subterranean formation, the composition is used in the subterranean formation, at least one of alone and in combination with other materials, as stimulation fluid, fracturing fluid, spotting fluid, remedial treatment fluid, acidizing fluid, conformance fluid, pill, packer fluid, logging fluid, or a combination thereof.

Embodiment 94 provides the method of any one of Embodiments 1-93, wherein the composition further comprises water, saline, aqueous base, oil, organic solvent, synthetic fluid oil phase, aqueous solution, alcohol or polyol, cellulose, starch, alkalinity control agent, acidity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, oil-wetting agent, set retarding additive, surfactant, corrosion inhibitor, gas, weight reducing additive, heavy-weight additive, lost circulation material, filtration control additive, salt, fiber, thixotropic additive, breaker, crosslinker, gas, rheology modifier, curing accelerator, curing retarder, pH modifier, chelating agent, scale inhibitor, enzyme, resin, water control material, polymer, oxidizer, a marker, shale, zeolite, a crystalline silica compound, amorphous silica, fibers, a hydratable clay, microspheres, pozzolan lime, or a combination thereof.

Embodiment 95 provides the method of any one of Embodiments 1-94, wherein the placing of the composition in the subterranean formation comprises fracturing at least part of the subterranean formation to form at least one subterranean fracture.

Embodiment 96 provides the method of any one of Embodiments 1-95, wherein the composition further comprises a proppant, a resin-coated proppant, or a combination thereof.

Embodiment 97 provides the method of any one of Embodiments 1-96, wherein the placing of the composition in the subterranean formation comprises pumping the composition through a tubular disposed in a wellbore and into the subterranean formation.

Embodiment 98 provides a system for performing the method of any one of Embodiments 1-97, the system comprising:

a tubular disposed in the subterranean formation; and

a pump configured to pump the composition in the subterranean formation through the tubular.

Embodiment 99 provides a method of treating a subterranean formation, the method comprising:

placing in a subterranean formation an aqueous composition comprising
a compound comprising at least one secondary or tertiary amine group, wherein at least one of (A), (B), and (C):
   (A) the compound comprising the amine has the structure:

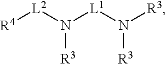

wherein at least one of (A1), (A2), and (A3):
   (A1) L¹ is —(C₁-C₁₀)alkylene-,
      L² is a bond,
      R³ is (C₁-C₁₀)hydrocarbyl, and
      R⁴ is R³,
   (A2) L¹ is —(C₁-C₁₀)alkylene-,
      L² is (C₁-C₁₀)hydrocarbylene-(NR²—(C₁-C₁₀)hydrocarbylene)ₙ-,
      at each occurrence, n is independently about 1 to about 10,
      at each occurrence R³ is chosen from —H and (C₁-C₁₀)hydrocarbyl, and
      R⁴ is (C₅-C₉₀)alkyl interrupted by 0, 1, 2, or 3 ethenylene groups, and
   (A3) L¹ is —C(O)—(C₁-C₉)alkyl-,
      L² is a bond,
      R³ is (C₁-C₁₀)hydrocarbyl, and
      R⁴ is (C₅-C₉₀)alkyl interrupted by 0, 1, 2, or 3 alkenylene groups,
(B) the compound comprising the amine has the structure:

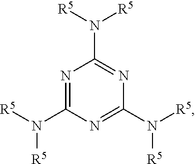

wherein
   at each occurrence R⁵ is independently chosen from —H, (C₁-C₂₀)alkyl, and (C₁-C₂₀)alkyl-NR⁶₂,
   each R⁵-substituted amino group has at least one R⁵ that is H, and
   at each occurrence R⁶ is independently (C₁-C₂₀)alkyl, and
(C) the compound comprising the at least one secondary or tertiary amine is a polymer comprising at least one repeating group that comprises at least one of the one or more secondary or tertiary amines, the repeating group having the structure:

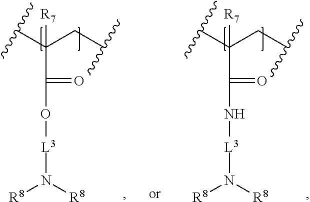

wherein
   R⁷ is chosen from —H and a substituted or unsubstituted (C₁-C₅)alkyl group,
   L³ is (C₁-C₁₀)alkylene, and
   R⁸ is independently (C₁-C₁₀)alkyl;

bubbling a gas comprising CO₂ through the aqueous composition sufficient to protonate or carboxylate the amine group and increase the viscosity of the aqueous composition; and

at least one of fracturing the subterranean formation with the composition or gravel packing the subterranean formation with the composition.

Embodiment 100 provides the method of Embodiment 99, wherein the aqueous composition further comprises a nanomaterial.

Embodiment 101 provides a system comprising:

an aqueous composition comprising a compound comprising at least one secondary or tertiary amine group; and

a subterranean formation comprising the composition therein.

Embodiment 102 provides the system of Embodiment 101, further comprising

a tubular disposed in the subterranean formation; and

a pump configured to pump the composition in the subterranean formation through the tubular.

Embodiment 103 provides an aqueous composition for fracturing or gravel packing of a subterranean formation, the composition comprising:

a compound comprising at least one secondary or tertiary amine group.

Embodiment 104 provides the composition of Embodiment 103, wherein the composition further comprises a downhole fluid.

Embodiment 105 provides the composition of any one of Embodiments 103-104, wherein the compound comprising at least one secondary or tertiary amine group is protonated or carboxylated.

Embodiment 106 provides an aqueous composition for treatment of a subterranean formation, the composition comprising:

a compound comprising at least one secondary or tertiary amine group, wherein at least one of (A), (B), and (C):
(A) the compound comprising the amine has the structure:

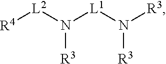

wherein at least one of (A1), (A2), and (A3):
   (A1) L¹ is —(C₁-C₁₀)alkylene-,
      L² is a bond,
      R³ is (C₁-C₁₀)hydrocarbyl, and
      R⁴ is R³,
   (A2) L¹ is —(C₁-C₁₀)alkylene-,
      L² is (C₁-C₁₀)hydrocarbylene-(NR²—(C₁-C₁₀)hydrocarbylene)ₙ-,
      at each occurrence, n is independently about 1 to about 10,
      at each occurrence R³ is chosen from —H and (C₁-C₁₀)hydrocarbyl, and
      R⁴ is (C₅-C₉₀)alkyl interrupted by 0, 1, 2, or 3 ethenylene groups, and
   (A3) L¹ is —C(O)—(C₁-C₉)alkyl-,
      L² is a bond,
      R³ is (C₁-C₁₀)hydrocarbyl, and
      R⁴ is (C₅-C₉₀)alkyl interrupted by 0, 1, 2, or 3 alkenylene groups,
(B) the compound comprising the amine has the structure:

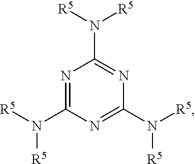

wherein
   at each occurrence R⁵ is independently chosen from —H, (C₁-C₂₀)alkyl, and (C₁-C₂₀)alkyl-NR⁶₂,
   each R⁵-substituted amino group has at least one R⁵ that is H, and
   at each occurrence R⁶ is independently (C₁-C₂₀)alkyl, and
(C) the compound comprising the at least one secondary or tertiary amine is a polymer comprising at least one repeating group that comprises at least one of the one or more secondary or tertiary amines, the repeating group having the structure:

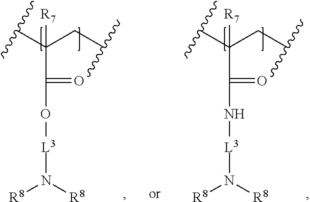

wherein
   R⁷ is chosen from —H and a substituted or unsubstituted (C₁-C₅)alkyl group,
   L³ is (C₁-C₁₀)alkylene, and
   R⁸ is independently (C₁-C₁₀)alkyl.

Embodiment 107 provides the aqueous composition of Embodiment 106, further comprising a nanomaterial.

Embodiment 108 provides a method of preparing a composition for treatment of a subterranean formation, the method comprising:

forming an aqueous composition comprising a compound comprising at least one secondary or tertiary amine group.

Embodiment 109 provides the composition, method, or system of any one or any combination of Embodiments 1-108 optionally configured such that all elements or options recited are available to use or select from.

1.-108. (canceled)

109. A method of treating a subterranean formation, comprising:
placing an aqueous composition into a subterranean formation, the aqueous composition comprising a compound containing an amine group; and
bubbling a gas comprising carbon dioxide through the aqueous composition sufficient to protonate or carboxylate the amine group and increase the viscosity of the aqueous composition,
wherein the compound containing the amine group has the chemical formula: 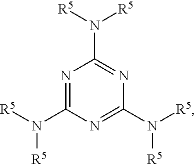
wherein at each occurrence R⁵ is independently chosen from —H and substituted or unsubstituted (C₁-C₂₀)hydrocarbyl-NR⁶₂ interrupted by 0, 1, 2, or 3 groups independently chosen from —O—, —S—, substituted or unsubstituted —NH—, —(O—(C₁-C₁₀)hydrocarbylene)ₙ-, and —(NR⁶—(C₁-C₁₀₀)hydrocarbylene)ₙ-,
at each occurrence, R⁶ is independently chosen from —H, substituted or unsubstituted (C₁-C₂₀)hydrocarbyl, and —((C₁-C₁₀)hydrocarbylene-NR⁵)ₙ—,
each (C₁-C₁₀)hydrocarbyl is independently substituted or unsubstituted, and
at each occurrence, n is independently from 1 to about 10,000.

110. The method of claim 109, further comprising at least one of fracturing the subterranean formation and gravel packing the subterranean formation with the aqueous composition.

111. The method of claim 109, wherein the aqueous composition further comprises a surfactant, and wherein the compound comprising the protonated or carboxylated amine group bridges multiple molecules of the surfactant.

112. The method of claim 109, wherein the aqueous composition further comprises at least one nanomaterial, and wherein the nanomaterial comprises at least one of ZnO, berlinite (AlPO₄), lithium tantalate (LiTaO₃), gallium orthophosphate (GaPO₄), BaTiO₃, SrTiO₃, PbZrTiO₃, KNbO₃, LiNbO₃, BiFeO₃, sodium tungstate, Ba₂NaNb₅O₅, Pb₂KNb₅O₁₅, potassium sodium tartrate, tourmaline, topaz, or any combination thereof.

113. The method of claim 109, wherein two R⁵-substituted amino groups each have two R⁵ that are H.

114. The method of claim 109, wherein at each occurrence R⁵ is independently chosen from —H and (C₁-C₂₀)alkyl-NR⁶₂.

115. The method of claim 109, wherein at each occurrence R⁶ is independently chosen from —H and (C₁-C₂₀)hydrocarbyl.

116. The method of claim 109, wherein
at each occurrence R⁵ is independently chosen from —H, (C₁-C₂₀)alkyl, and (C₁-C₂₀)alkyl-NR⁶₂,
each R⁵-substituted amino group has at least one R⁵ that is H, and
at each occurrence R⁶ is independently (C₁-C₂₀)alkyl.

117. The method of claim 109, wherein the compound containing the amine group has a chemical formula chosen from:

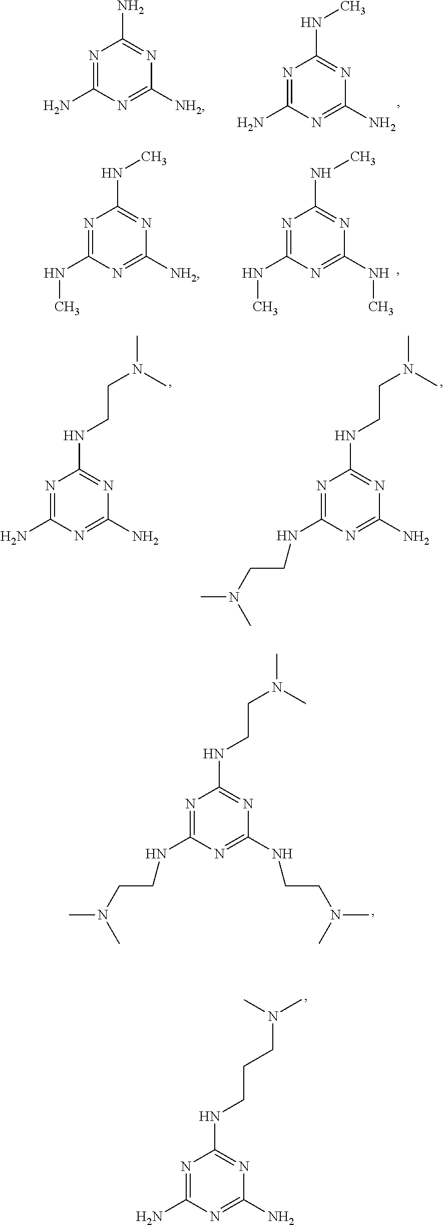

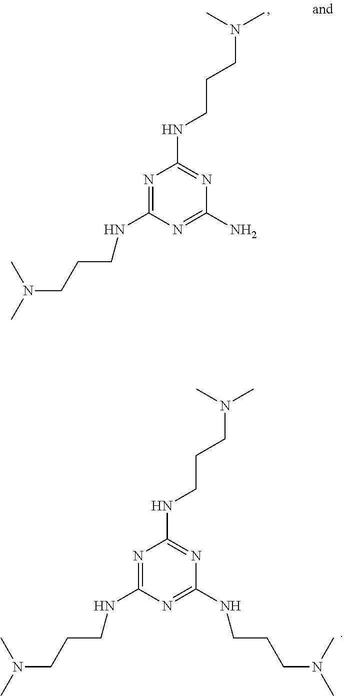

118. The method of claim 109, wherein the compound containing the amine group is a polymer comprising at least one ethenylene repeating unit that includes the amine group as a substituent thereof, wherein the ethenylene repeating unit is otherwise substituted or unsubstituted.

119. The method of claim 118, wherein the amine group is bound to the ethenylene repeating unit via a —C(O)—O-L³- group, wherein L³ is a substituted or unsubstituted (C₁-C₂₀)hydrocarbylene.

120. A method of treating a subterranean formation, comprising:
placing an aqueous composition into a subterranean formation, the aqueous composition comprising a compound containing an amine group; and
bubbling a gas comprising carbon dioxide through the aqueous composition sufficient to protonate or carboxylate the amine group and increase the viscosity of the aqueous composition,
wherein the compound containing the amine group is selected from (A) or (B):
(A) the compound containing the amine group is a polymer comprising at least one repeating group that comprises the amine group, the repeating group has the chemical formula: 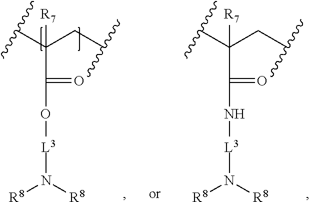
wherein:
R⁷ is chosen from —H and a substituted or unsubstituted (C₁-C₅)alkyl group,
at each occurrence, R⁸ is independently chosen from —H and substituted or unsubstituted (C₁-C₂₀)hydrocarbyl-NR⁹₂ interrupted by 0, 1, 2, or 3 groups independently chosen from —O—, —S—, substituted or unsubstituted —NH—, —(O—(C₁-C₁₀)hydrocarbylene)ₙ-, and —(NR⁹—(C₁-C₁₀)hydrocarbylene)ₙ-,
at each occurrence, R⁹ is independently chosen from —H, substituted or unsubstituted (C₁-C₂₀)hydrocarbyl, and —((C₁-C₁₀)hydrocarbylene-NR)ₙ—,
L³ is a substituted or unsubstituted (C₁-C₂₀)hydrocarbylene, and
at each occurrence, n is from 1 to about 10,000; or
(B) the compound containing the amine group has the chemical formula: 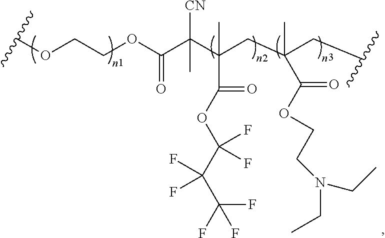
wherein:
n1, n2, and n3 are independently from 1 to about 10,000.

121. The method of claim 120, wherein the compound containing the amine group is selected from (A), and wherein L³ is (C₁-C₁₀)alkylene and at each occurrence, R⁸ is independently (C₁-C₁₀)alkyl.

122. The method of claim 120, wherein the compound containing the amine group is selected from (A), and wherein R⁷ is methyl, R⁸ is ethyl, and L³ is ethylene.

123. The method of claim 120, wherein the compound containing the amine group is selected from (A), and wherein:
R⁷ is chosen from —H and a substituted or unsubstituted (C₁-C₅)alkyl group,
L³ is (C₁-C₁₀)alkylene, and
R⁸ is independently (C₁-C₁₀)alkyl.

124. The method of claim 120, wherein the compound containing the amine group is selected from (B), and wherein the compound containing the amine group has the chemical formula:

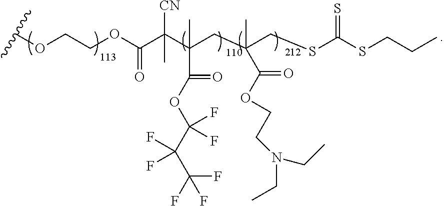

125. A system for performing the method of claim 120, the system comprising:
a tubular disposed in the subterranean formation; and
a pump configured to pump the aqueous composition in the subterranean formation through the tubular.

126. A method of treating a subterranean formation, comprising:
placing an aqueous composition into a subterranean formation, the aqueous composition comprising:
a compound comprising at least one secondary or tertiary amine group, wherein at least one of (A), (B), and (C):
(A) the compound containing the amine group has the chemical formula: 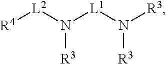
wherein at least one of (A1), (A2), and (A3):
(A1):
L is —(C₁-C₁₀)alkylene-,
L² is a bond,
R³ is (C₁-C₁₀)hydrocarbyl, and
R⁴ is R³,
(A2):
L is —(C₁-C₁₀)alkylene-,
L² is (C₁-C₁₀)hydrocarbylene-(NR²—(C₁-C₁₀)hydrocarbylene)ₙ-,
at each occurrence, n is independently from 1 to about 10,
at each occurrence R³ is chosen from —H and (C₁-C₁₀)hydrocarbyl, and
R⁴ is (C₅-C₉₀)alkyl interrupted by 0, 1, 2, or 3 ethenylene groups, and
(A3):
L¹ is —C(O)—(C₁-C₉)alkyl-,
L² is a bond,
R³ is (C₁-C₁₀)hydrocarbyl, and
R⁴ is (C₅-C₉₀)alkyl interrupted by 0, 1, 2, or 3 alkenylene groups,
(B) the compound containing the amine group has the chemical formula: 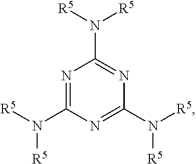
wherein:
at each occurrence R⁵ is independently chosen from —H, (C₁-C₂₀)alkyl, and (C₁-C₂₀)alkyl-NR⁶₂,
each R⁵-substituted amino group has at least one R⁵ that is H, and
at each occurrence R⁶ is independently (C₁-C₂₀)alkyl, and
(C) the compound comprising the at least one secondary or tertiary amine is a polymer comprising at least one repeating group that comprises at least one of the one or more secondary or tertiary amines, the repeating group has the chemical formula: 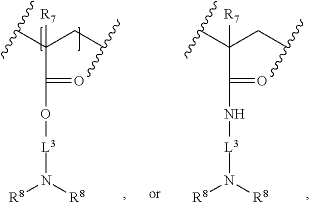
wherein:
R⁷ is chosen from —H and a substituted or unsubstituted (C₁-C₅)alkyl group,
L³ is (C₁-C₁₀)alkylene, and
R⁸ is independently (C₁-C₁₀)alkyl;
bubbling a gas comprising CO₂ through the aqueous composition sufficient to protonate or carboxylate the amine group and increase the viscosity of the aqueous composition; and
at least one of fracturing the subterranean formation with the aqueous composition or gravel packing the subterranean formation with the aqueous composition.

127. The method of claim 126, wherein the aqueous composition further comprises a nanomaterial, and wherein the nanomaterial comprises at least one of ZnO, berlinite (AlPO₄), lithium tantalate (LiTaO₃), gallium orthophosphate (GaPO₄), BaTiO₃, SrTiO₃, PbZrTiO₃, KNbO₃, LiNbO₃, BiFeO₃, sodium tungstate, Ba₂NaNb₅O₅, Pb₂KNb₅O₁₅, potassium sodium tartrate, tourmaline, topaz, or any combination thereof.

128. An aqueous composition for treatment of a subterranean formation, comprising:
a compound comprising at least one secondary or tertiary amine group, wherein at least one of (A), (B), and (C):
(A) the compound containing the amine group has the chemical 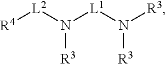
wherein at least one of (A1), (A2), and (A3):
(A1):
L is —(C₁-C₁₀)alkylene-,
L² is a bond,
R³ is (C₁-C₁₀)hydrocarbyl, and
R⁴ is R³,
(A2):
L¹ is —(C₁-C₁₀)alkylene-,
L² is (C₁-C₁₀)hydrocarbylene-(NR²—(C₁-C₁₀)hydrocarbylene)ₙ-,
at each occurrence, n is independently from 1 to about 10,
at each occurrence R³ is chosen from —H and (C₁-C₁₀)hydrocarbyl, and
R⁴ is (C₅-C₉₀)alkyl interrupted by 0, 1, 2, or 3 ethenylene groups, and
(A3):
L is —C(O)—(C₁-C₉)alkyl-,
L² is a bond,
R³ is (C₁-C₁₀)hydrocarbyl, and
R⁴ is (C₅-C₉₀)alkyl interrupted by 0, 1, 2, or 3 alkenylene groups,
(B) the compound containing the amine group has the chemical formula: 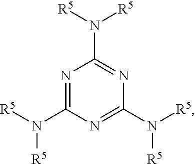
wherein:
at each occurrence R⁵ is independently chosen from —H, (C₁-C₂₀)alkyl, and (C₁-C₂₀)alkyl-NR⁶₂,
each R⁵-substituted amino group has at least one R⁵ that is H, and
at each occurrence R⁶ is independently (C₁-C₂₀)alkyl, and
(C) the compound comprising the at least one secondary or tertiary amine is a polymer comprising at least one repeating group that comprises at least one of the one or more secondary or tertiary amines, the repeating group has the chemical formula: 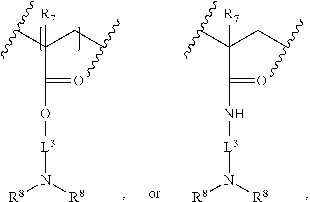
wherein:
R⁷ is chosen from —H and a substituted or unsubstituted (C₁-C₅)alkyl group,
L³ is (C₁-C₁₀)alkylene, and
R⁸ is independently (C₁-C₁₀)alkyl.
